(19) United States
(12) Patent Application Publication
(10) Pub. No.: US 2016/0127227 A1
(43) Pub. Date: May 5, 2016

(54) INFORMATION PROCESSING SYSTEM, METHOD, AND APPARATUS

(71) Applicant: FUJITSU LIMITED, Kawasaki-shi (JP)

(72) Inventors: Chunghan LEE, Kawasaki (JP); TAKESHI SHIMIZU, Kawasaki (JP)

(73) Assignee: FUJITSU LIMITED, Kawasaki-shi (JP)

(21) Appl. No.: 14/887,799

(22) Filed: Oct. 20, 2015

(30) Foreign Application Priority Data
Nov. 5, 2014 (JP) 2014-225635

(51) Int. Cl. H04L 12/721; H04L 12/26

(52) U.S. Cl. CPC H04L 45/70; H04L 43/022

(57) ABSTRACT

A system includes: a switch apparatus transmitting a flow received from a first apparatus to a second apparatus; and an identification apparatus identifying a packet in the flow. The switch apparatus snoops a start packet indicating start of coupling, snoops a packet in a flow related to flow information for identifying the flow based on a snoop instruction including the flow information, and transmits the snooped packet to the identification apparatus. The identification apparatus stores correspondence information storing flow information regarding each flow in regard to the flow, registers flow information regarding a flow including the start packet in the correspondence information based on the snooped start packet, transmits the snoop instruction when a first time passes in regard to each flow of which the flow information is registered in the correspondence information, and determine whether a target flow is a predetermined flow based on the snooped packet.

### CROSS-REFERENCE TO RELATED APPLICATION

This application is based upon and claims the benefit of priority of the prior Japanese Patent Application No. 2014-225635, filed on Nov. 5, 2014, the entire contents of which are incorporated herein by reference.

### FIELD

The embodiments discussed herein are related to an information processing system, a method, and an apparatus.

### BACKGROUND

Flows flowing in networks such as data centers, mice flows and elephant flows are known to be intermingled. Elephant flows are less frequent than mice flows, but transmit a larger amount of data than mice flows. For this reason, delay or congest occurs in networks due to elephant flows in some cases. Therefore, transmission paths of elephant flows are monitored and controlled in networks.

There are known technologies for sampling packets flowing in networks at predetermined sampling rates in nodes of the networks, assuming probability distribution models for the sampled packets, and determining whether the sampled packets are packets of huge flows. Further, there are known technologies for sampling packets flowing in networks at intervals of a predetermined number of packets in nodes of the networks and setting flows including the sampled packets as monitoring targets when an SYN flags are set in the sampled packets.

As a related technical document, there are Japanese Laid-open Patent Publication No. 2009-267892 and Japanese Laid-open Patent Publication No. 2011-4333.

### SUMMARY

According to an aspect of the invention, an information processing system includes: a switch apparatus configured to transmit a flow received from a first information processing apparatus to a second information processing apparatus; and an identification apparatus configured to identify a packet included in the flow received by the switch apparatus, wherein the switch apparatus is configured to: snoop a start packet indicating start of coupling, snoop a packet included in a flow related to flow information for identifying the flow when a snoop instruction including the flow information is received from the identification apparatus, and transmit the snooped packet to the identification apparatus, and wherein the identification apparatus is configured to: store correspondence information storing flow information regarding each flow in regard to the flow, register flow information regarding a flow including the start packet in the correspondence information when the snooped start packet is received, transmit the snoop instruction including the flow information regarding the flow to the switch apparatus when a first time passes in regard to each flow of which the flow information is registered in the correspondence information, and determine whether the flow identified with the flow information included in the snoop instruction is a predetermined flow based on a value calculated from information owned by the snooped packet when the snooped packet is received from the switch apparatus in response to the snoop instruction.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of an information processing system;

FIG. 2 is a diagram illustrating an example of switch apparatuses according to a first embodiment;

FIG. 3 is a diagram illustrating an example of a flow table;

FIG. 4 is a diagram illustrating an example of a PDU;

FIG. 5 is a diagram for describing a packet header;

FIG. 6 is a diagram illustrating an example of an identification apparatus according to the first embodiment;

FIG. 7 is a diagram illustrating an example of a monitor table according to the first embodiment;

FIGS. 8 and 9 are diagrams for describing an example of a method of determining an elephant flow according to the first embodiment;

FIG. 10 is a diagram for describing an example of state transition in the determination of the elephant flow;

FIG. 11 is a flowchart illustrating an example of an operation of the switch apparatus according to the first embodiment;

FIGS. 12 and 13 are flowcharts illustrating an example of an operation of the identification apparatus according to the first embodiment;

FIG. 14 is a diagram illustrating an example of a switch apparatus according to a second embodiment;

FIG. 15 is a diagram illustrating an example of an identification apparatus according to a third embodiment;

FIG. 16 is a diagram illustrating an example of a route information table;

FIG. 17 is a diagram for describing an example of route information;

FIG. 18 is a diagram illustrating a monitor table according to the third embodiment;

FIG. 19 is a diagram illustrating an example of an RU table;

FIG. 20 is a diagram illustrating an example of a switch apparatus according to the third embodiment;

FIGS. 21 and 22 are diagrams for describing an example of a method of determining an elephant flow according to the third embodiment;

FIG. 23 is a flowchart illustrating an example of an operation of the switch apparatus according to the third embodiment;

FIG. 24 is a flowchart illustrating an example of an operation of the identification apparatus according to the third embodiment; and

FIG. 25 is a diagram illustrating an example of a computer realizing functions of a switch apparatus.

### DESCRIPTION OF EMBODIMENTS

When packets flowing in networks are sampled at predetermined sampling rates or at intervals of a predetermined number of packets, there is a concern that packets included in an elephant flow are not sampled depending on sampling timings. Therefore, information regarding the packets included in the elephant flow may not be obtained and it is difficult to comprehend transmission routes of the elephant flow in some cases. Further, a method of capturing all of the packets flowing in networks and detecting elephant flows using information regarding all of the packets can also be considered. However, when transmission speeds in the networks are high, it is difficult to capture and analyze all of the packets.

In embodiments, a predetermined flow such as an elephant flow is efficiently detected.

Hereinafter, embodiments will be described in detail with reference to the drawings. The following embodiments do not limit the technology of the present disclosure. The embodiments can be appropriately combined within a scope in which processing content is not inconsistent.

### First Embodiment

### Information Processing System 10

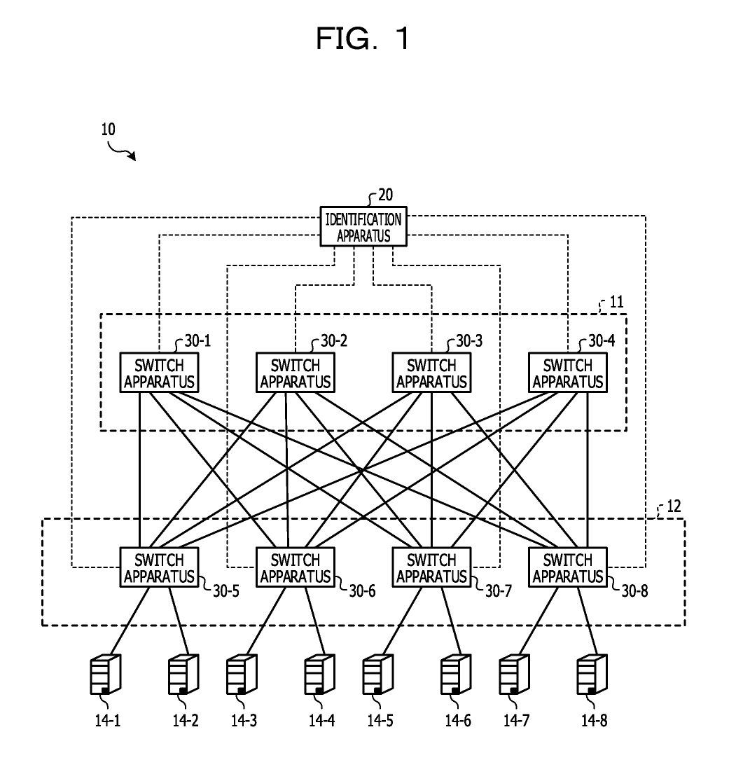

FIG. 1 is a diagram illustrating an example of an information processing system 10. The information processing system 10 includes an identification apparatus 20, a plurality of switch apparatuses 30-1, 30-2, 30-3, 30-4, 30-5, 30-6, 30-7, and 30-8, and a plurality of information processing apparatuses 14-1, 14-2, 14-3, 14-4, 14-5, 14-6, 14-7, and 14-8. The information processing system 10 is provided at, for example, a data center. Each of the plurality of information processing apparatuses 14-1 to 14-8 is, for example, a server. Hereinafter, when the plurality of switch apparatuses 30-1 to 30-8 are not distinguished from each other, the switch apparatuses 30-1 to 30-8 are referred to as the switch apparatuses 30. Further, when the plurality of information processing apparatuses 14-1 to 14-8 are not distinguished from each other, the information processing apparatuses 14-1 to 14-8 are referred to as the information processing apparatuses 14.

The information processing system 10 includes a higher switch group 11 including the plurality of switch apparatuses 30-1 to 30-4 and a lower switch group 12 including the plurality of switch apparatuses 30-5 to 30-8. The plurality of switch apparatuses 30-1 to 30-4 are, for example, spine switches. The plurality of switch apparatuses 30-5 to 30-8 are, for example, leaf switches. Each of the switch apparatuses 30-5 to 30-8 included in the lower switch group 12 is coupled to two or more of the switch apparatuses 30 among the plurality of switch apparatuses 30-1 to 30-4 included in the higher switch group 11. Each of the switch apparatuses 30-5 to 30-8 included in the lower switch group 12 is coupled to the information processing apparatus 14. The plurality of switch apparatuses 30 form, for example, a fat tree topology.

The switch apparatuses 30 are coupled to each other by, for example, data networks indicated by solid lines in FIG. 1. Each switch apparatus 30 is coupled to the identification apparatus 20 by, for example, a management network indicated by a dotted line in FIG. 1. The identification apparatus 20 according to the embodiment identifies an elephant flow among flows transmitted between the information processing apparatuses 14 via the switch apparatuses 30 based on information reported from the switch apparatuses 30. The flow refers to a group of a series of packets that have a common attribute and flow in a network. In the embodiment, a packet group in which a transmission source Internet Protocol (IP) address, a destination IP address, a transmission source port number, a destination port number, and a protocol number are common is referred to as a flow.

The identification apparatus 20 transmits flow information for specifying an elephant flow to the switch apparatuses 30 included in the lower switch group 12 coupled to the information processing apparatuses 14. The elephant flow refers to, for example, a flow for which a total amount of data to be transmitted is equal to or greater than a predetermined amount such as 1 MByte.

When the switch apparatus 30 included in the lower switch group 12 receives packets included in an elephant flow specified with flow information received from the identification apparatus 20 from the information processing apparatus 14, the switch apparatus 30 writes identification information indicating the elephant flow on the header of the received packet. Then, the switch apparatus 30 transmits the packet on which the identification information indicating the elephant flow is written on the header to the other switch apparatuses 30 such as the switch apparatuses 30 included in the higher switch group 11.

Each switch apparatus 30 can recognize that received packet is the packet included in the elephant flow with reference to the header of the received packet. Thus, in a predetermined scene such as a case in which congestion occurs in the information processing system 10, each switch apparatus 30 can early resolve a congestion state or protect the elephant flow by performing control, for example, changing a route of the packets included in the elephant flow.

Switch Apparatus 30

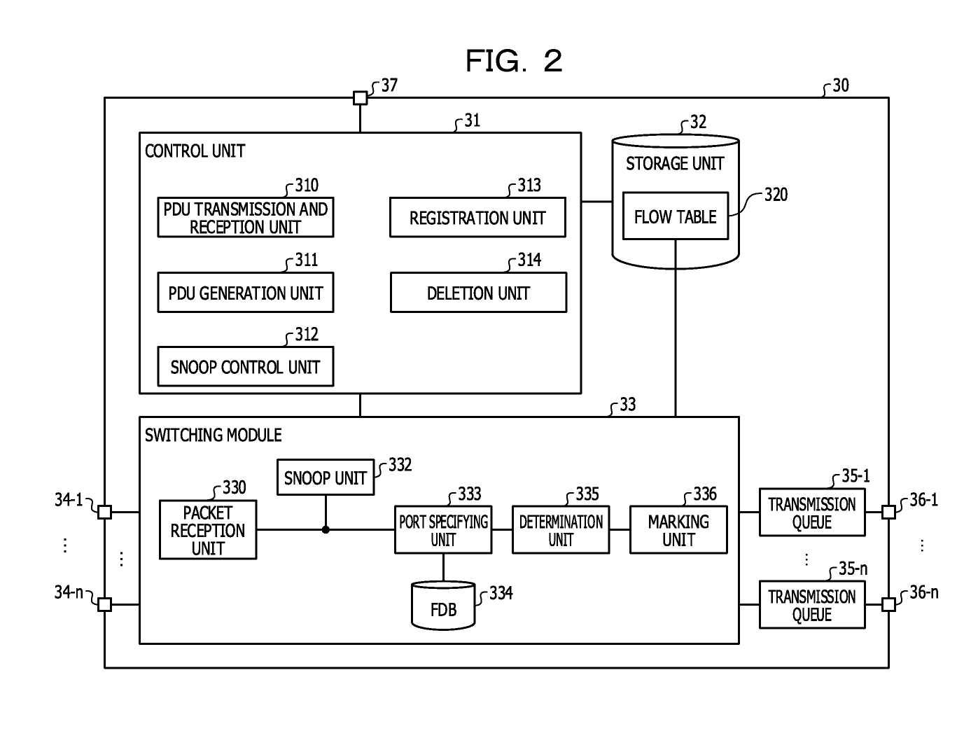

FIG. 2 is a diagram illustrating an example of the switch apparatus 30 according to the first embodiment. The switch apparatus 30 includes a control unit 31, a storage unit 32, a switching module 33, a plurality of reception ports 34-1 to 34-n, a plurality of transmission queues 35-1 to 35-n, a plurality of transmission ports 36-1 to 36-n, and a management port 37. The plurality of reception ports 34-1 to 34-n are coupled to the information processing apparatuses 14 or the other switch apparatuses 30 via data networks. The plurality of transmission ports 36-1 to 36-n are coupled to the information processing apparatuses 14 or the other switch apparatuses 30 via data networks. The management port 37 is coupled to the identification apparatus 20 via a management network.

Hereinafter, when the plurality of reception ports 34-1 to 34-n are not distinguished from each other, the plurality of reception ports 34-1 to 34-n are collectively referred to as the reception ports 34. When the plurality of transmission queues 35-1 to 35-n are not distinguished from each other, the plurality of transmission queues 35-1 to 35-n are collectively referred to as the transmission queues 35. When the plurality of transmission ports 36-1 to 36-n are not distinguished from each other, the plurality of transmission ports 36-1 to 36-n are collectively referred to as the transmission ports 36.

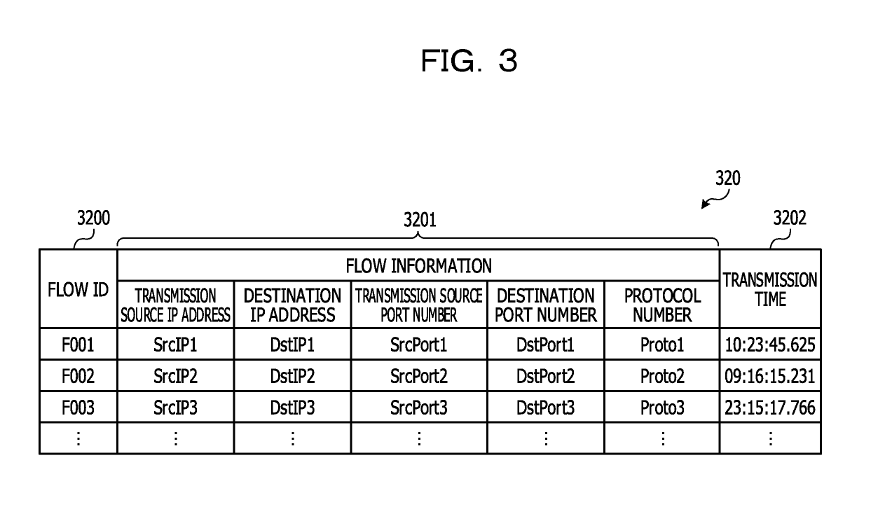

The storage unit 32 stores a flow table 320. FIG. 3 is a diagram illustrating an example of the flow table 320. In the flow table 320, for example, as illustrated in FIG. 3, a flow ID 3200, flow information 3201, and a transmission time 3202 are stored in association therewith.

The flow ID 3200 is information for identifying each flow. The flow information 3201 is information regarding a header commonly owned by packets included in a flow. In the embodiment, the flow information 3201 includes a transmission source IP address, a destination IP address, a transmission source port number, a destination port number, and a protocol number. In the embodiment, in the flow table 320, the flow ID 3200, the flow information 3201, and the transmission time 3202 of a flow determined to be an elephant flow by the identification apparatus 20 are stored.

The transmission time 3202 indicates a time at which a packet included in the elephant flow corresponding to the flow ID 3200 and having a header on which identification information indicating the flow is the elephant flow is written is transmitted.

Referring back to FIG. 2, the description will be continued. The control unit 31 includes a PDU transmission and reception unit 310, a PDU generation unit 311, a snoop control unit 312, a registration unit 313, and a deletion unit 314. When the PDU transmission and reception unit 310 receives a protocol data unit (PDU) from the identification apparatus 20 via the management port 37, the PDU transmission and reception unit 310 transmits a payload included in the received PDU to the snoop control unit 312 and the registration unit 313. The PDU transmission and reception unit 310 transmits the PDU generated by the PDU generation unit 311 to the identification apparatus 20 via the management port 37.

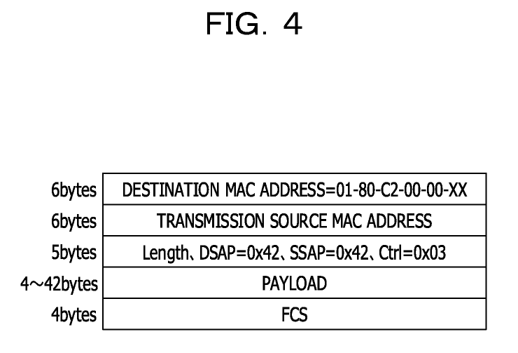

FIG. 4 is a diagram illustrating an example of a PDU. In the embodiment, when a flag, data, and the like are transmitted and received between the identification apparatus 20 and the switch apparatus 30 or between the switch apparatuses 30, for example, the PDU illustrated in FIG. 4 is used. In the embodiment, for example, a PDU defined in IEEE 802.1Q is used. A scheduled MAC address, 01-80-C2-00-00-XX, is stored in a destination media access control (MAC) address of the PDU. The payload of the PDU includes a flag and data used for a process identified by the flag. The flag included in the payload is expressed by, for example, 8 bits. The data included in the payload include flow information, a sequence number, and a flow ID.

In the embodiment, the flow information includes a transmission source IP address, a destination IP address, a transmission source port number, a destination port number, and a protocol number. An IP address in IPv6 has 16 bytes. Therefore, when flow information of IPv6 is included, the size of the payload including the flag, the flow information, and the sequence number is 42 bytes.

When the header of a start packet is received from the switching module 33, the snoop control unit 312 extracts the flow information and the sequence number of the flow including the start packet from the received header. Then, the snoop control unit 312 transmits the extracted flow information and sequence number to the PDU generation unit 311 along with a flag indicating reception of the start packet.

When the header of an interrupt packet is received from the switching module 33, the snoop control unit 312 extracts flow information regarding the flow including the interrupt packet from the received header. Then, the snoop control unit 312 transmits the extracted flow information to the PDU generation unit 311 and the deletion unit 314 along with a flag indicating end of the flow. When the header of an end packet is received from the switching module 33, the snoop control unit 312 extracts flow information regarding the flow including an end packet from the received header. Then, the snoop control unit 312 transmits the extracted flow information to the PDU generation unit 311 and the deletion unit 314 along with a flag indicating end of the flow.

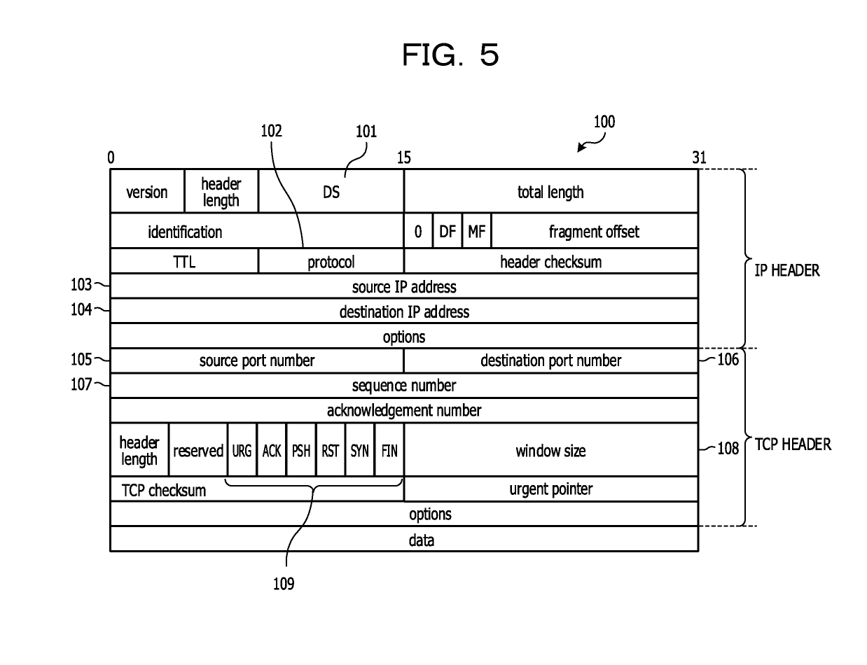

In the embodiment, for example, information illustrated in FIG. 5 is stored in the header of a packet to be transmitted. FIG. 5 is a diagram illustrating the header of a packet 100. The header of the packet 100 includes an IP header and a Transmission Control Protocol (TCP) header. For example, as illustrated in FIG. 5, the IP header includes a differentiated services (DS) field 101, a protocol number 102, a transmission source IP address 103, and a destination IP address 104. For example, as illustrated in FIG. 5, the TCP header includes a transmission source port number 105, a destination port number 106, a sequence number 107, a window size 108, and a control flag 109.

A differentiated services code point (DSCP) field can be allocated to lower 6 bits of the DS field 101. The control flag 109 includes an SYN bit for which 1 is stored in the case of a start packet and an RST bit for which 1 is stored in the case of an interrupt packet. The control flag 109 further includes an FIN bit for which 1 is stored in the case of an end packet and an ACK bit for which 1 is stored in the case of a response packet.

When the payload of the PDU is received from the PDU transmission and reception unit 310, the snoop control unit 312 extracts the flag and the data from the payload. When the flag extracted from the payload is a snoop instruction, the snoop control unit 312 transmits the flow information included in the data extracted from the payload to the switching module 33.

When the packet included in the flow corresponding to the flow information is snooped, the snoop control unit 312 receives the header of the snooped packet from the switching module 33. The snoop control unit 312 extracts the sequence number from the received header and transmits the extracted sequence number and the flow information extracted from the payload of the PDU along with a flag indicating snoop success to the PDU generation unit 311. Conversely, when the packet included in the flow corresponding to the flow information is not snooped, the snoop control unit 312 receives information indicating snoop failure from the switching module 33. The snoop control unit 312 transmits the flow information extracted from the payload along with a flag indicating the snoop failure to the PDU generation unit 311.

When the payload of the PDU is received from the PDU transmission and reception unit 310, the registration unit 313 extracts the flag and the data from the payload. When the flag indicates registration, the registration unit 313 registers the flow information included in the data extracted from the payload in the flow table 320 in association with the flow ID included in the data extracted from the payload. Then, the registration unit 313 registers a current time in an update time field in association with the flow ID included in the data extracted from the payload.

The deletion unit 314 monitors whether an available capacity of the storage unit 32 is less than a predetermined value. The predetermined value is, for example, 20% of the capacity of the storage unit 32. When the available capacity of the storage unit 32 is less than the predetermined value, the deletion unit 314 deletes predetermined flow information among the flow information associated with the flow IDs from the flow table 320 with reference to the flow table 320. The predetermined flow information is, for example, flow information associated with an update time for which a time elapsed from an update hour is equal to or greater than predetermined time. Even when the available capacity of the storage unit 32 is less than a predetermined value, the deletion unit 314 may delete the flow information associated with the update hour in which the elapsed time is the predetermined time such as 5 or more minutes from the flow table 320.

When the flow information is received along with the flag indicating the end of the flow from the snoop control unit 312, the deletion unit 314 determines whether the flow information received from the snoop control unit 312 is present in the flow table 320 with reference to the flow table 320. When the flow information received from the snoop control unit 312 is present in the flow table 320, the deletion unit 314 deletes an entry including the flow information received from the snoop control unit 312 from the flow table 320.

When the flow information and the sequence number are received along with the flag indicating reception of the start packet from the snoop control unit 312, the PDU generation unit 311 generates a payload including the flag indicating the reception of the start packet, the flow information, and the sequence number. When the flow information is received along with the flag indicating the end of the flow from the snoop control unit 312, the PDU generation unit 311 generates a payload including the flag indicating the end of the flow and the flow information.

When the flow information and the sequence number are received along with the flag indicating snoop success from the snoop control unit 312, the PDU generation unit 311 generates a payload including the flag indicating the snoop success, the flow information, and the sequence number. Further, when the flow information is received along with the flag indicating the snoop failure from the snoop control unit 312, the PDU generation unit 311 generates a payload including the flag indicating the snoop failure and the flow information.

The PDU generation unit 311 generates a PDU which includes the generated payloads and in which the MAC address of the identification apparatus 20 is set as a destination MAC address. Then, the PDU generation unit 311 transmits the generated PDU to the PDU transmission and reception unit 310.

The switching module 33 includes a packet reception unit 330, a snoop unit 332, a port specifying unit 333, a forwarding data base (FDB) 334, a determination unit 335, and a marking unit 336. When the packet reception unit 330 receives packets via the reception ports 34, the received packets are transmitted to the snoop unit 332 and the port specifying unit 333.

The snoop unit 332 snoops predetermined packets among the packets received by the packet reception unit 330. Then, the snoop unit 332 transmits the headers of the snooped packets to the snoop control unit 312. The predetermined packets are, for example, the start packet, the interrupt packet, and the end packet. The start packet is, for example, a packet in which 1 is stored in the SYN bit in the TCP header. The interrupt packet is, for example, a packet in which 1 is stored in the RST bit in the TCP header. The end packet is, for example, a packet in which 1 is stored in the FIN bit in the TCP header.

When the flow information is received from the snoop control unit 312, the snoop unit 332 snoops the packets in which the flow information received from the snoop control unit 312 is included in the header among the packets received by the packet reception unit 330 for a predetermined time. The predetermined time in the embodiment is, for example, 50 milliseconds. When the packets in which the flow information received from the snoop control unit 312 is included in the header are snooped within the predetermined time, the snoop unit 332 transmits the headers of the snooped packets to the snoop control unit 312. Conversely, when the packets in which the flow information received from the snoop control unit 312 is included in the header are not snooped within the predetermined time, the snoop unit 332 transmits information indicating the snoop failure to the snoop control unit 312.

The port numbers of the transmission ports 36 are stored in the FDB 334 in association with the MAC address. When the packets are received from the packet reception unit 330, the port specifying unit 333 specifies the port numbers associated with the destination MAC address in the headers of the packets received from the packet reception unit 330 with reference to the FDB 334. Then, the port specifying unit 333 transmits the specified port numbers along with the packets received from the packet reception unit 330 to the determination unit 335.

When the packets are received from the port specifying unit 333, the determination unit 335 determines whether the flow information in the headers of the received packets is registered in the flow table 320 with reference to the flow table 320. When the flow information in the headers of the packets received from the port specifying unit 333 is registered in the flow table 320, the packets received from the port specifying unit 333 are an elephant flow.

When the flow information in the headers of the packets received from the port specifying unit 333 is registered in the flow table 320, the determination unit 335 transmits the packets received from the port specifying unit 333 along with the port numbers received from the port specifying unit 333 to the marking unit 336. Conversely, when the flow information in the headers is not registered in the flow table 320, the determination unit 335 stores the packets received from the port specifying unit 333 in the transmission queues 35 coupled to the transmission ports 36 corresponding to the port numbers received from the port specifying unit 333.

When the packets are received from the determination unit 335, the marking unit 336 writes identification information indicating the packets included in the elephant flow in the headers of the received packets. The marking unit 336 stores the packets in which the identification information is written on the headers in the transmission queues 35 coupled to the transmission ports 36 corresponding to the port numbers received from the determination unit 335. The marking unit 336 updates transmission hours stored in the flow table 320 in association with the flow information in the headers of the packets received from the determination unit 335 to current hours.

In the embodiment, the marking unit 336 writes the identification information indicating the packet included in the elephant flow on the DSCP field allocated to lower 6 bits of the DS field in the IP header. As another example, the marking unit 336 may write the identification information indicating the packet included in the elephant flow on a class of service (CoS) field in a VLAN tag.

In the embodiment, for example, one transmission queue 35 is disposed for each transmission port 36. The number of plurality of transmission queues 35 may be different from the number of plurality of transmission ports 36. The transmission queues 35 transmit the packets stored by the determination unit 335 or the marking unit 336 from the transmission ports 36 coupled to the transmission queues 35.

Identification Apparatus 20

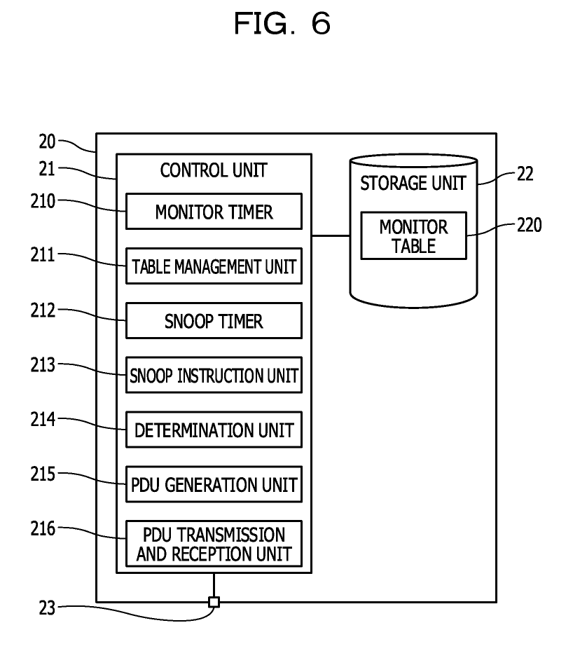

FIG. 6 is a diagram illustrating an example of the identification apparatus 20 according to the first embodiment. The identification apparatus 20 includes a control unit 21, a storage unit 22, and a management port 23. The management port 23 is coupled to each switch apparatus 30 via the management network.

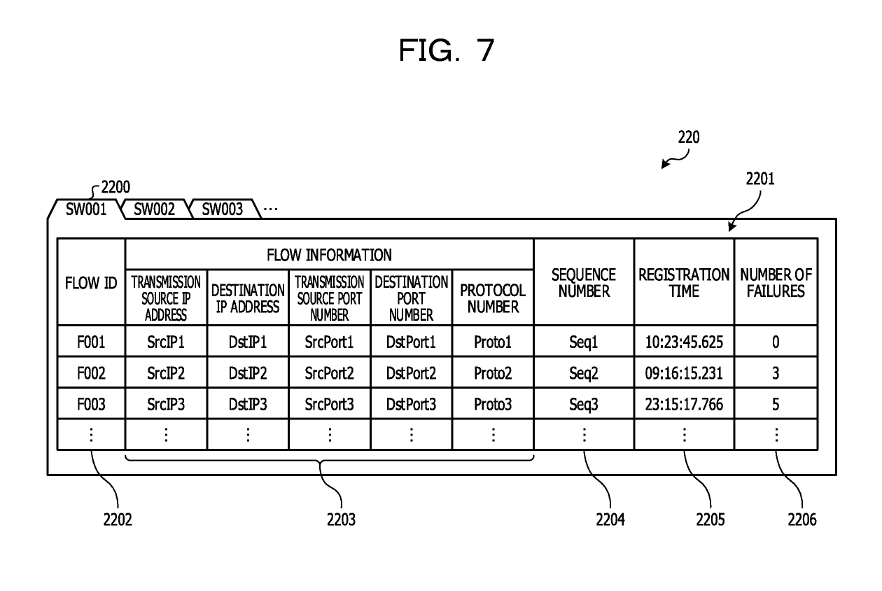

The storage unit 22 stores a monitor table 220. FIG. 7 is a diagram illustrating an example of the monitor table 220. For example, in the monitor table 220, as illustrated in FIG. 7, an individual table 2201 is stored for each switch ID 2200 for identifying each of the switch apparatuses 30. In each individual table 2201, a flow ID 2202, flow information 2203, a sequence number 2204, a registration time 2205, and the number of failures 2206 are stored in association therewith.

The flow ID 2202 is information for identifying each flow. The flow information 2203 is information regarding a header commonly owned by packets included in a flow. In the embodiment, the flow information 2203 includes a transmission source IP address, a destination IP address, a transmission source port number, a destination port number, and a protocol number.

The sequence number 2204 is a sequence number included in the header of a start packet transmitted at the time of start of the flow. The start packet refers to a packet in which 1 is set in the SYN bit in the TCP header. The registration time 2205 is a time at which the flow information 2203 and the sequence number 2204 are registered in the individual table 2201 in association with the flow ID 2202. The number of failures 2206 is the number of times the snoop fails.

Referring back to FIG. 6, the description will be continued. The control unit 21 includes a monitor timer 210, a table management unit 211, a snoop timer 212, a snoop instruction unit 213, a determination unit 214, a PDU generation unit 215, and a PDU transmission and reception unit 216. When the PDU transmission and reception unit 216 receives the PDU from the switch apparatus 30 via the management port 23, the PDU transmission and reception unit 216 transmits a payload included in the received PDU to the table management unit 211 and the determination unit 214. The PDU transmission and reception unit 216 transmits the PDU generated by the PDU generation unit 215 to the switch apparatus 30 via the management port 23.

When the payload of the PDU is received from the PDU transmission and reception unit 216, the table management unit 211 extracts the flag and the data from the payload. When the flag extracted from the payload indicates the reception of the start packet, the table management unit 211 allocates the flow ID to the flow specified with the flow information included in the data extracted from the payload. The table management unit 211 specifies an individual table corresponding to the switch apparatus 30 of the transmission source of the PDU with reference to the monitor table 220. The table management unit 211 registers the flow information and the sequence number included in the data extracted from the payload in association with the flow ID in the specified individual table. The table management unit 211 registers a current time as a registration time in the specified individual table in association with the flow ID and registers “0” as the number of failures.

When the flag extracted from the payload indicates snoop failure, the table management unit 211 specifies the individual table corresponding to the switch apparatus 30 of the transmission source of the PDU with reference to the monitor table 220. The table management unit 211 specifies the flow information included in the data extracted from the payload in the specified individual table. The table management unit 211 adds “1” to the number of failures associated with the specified flow information.

When the flag extracted from the payload indicates the end of the flow, the table management unit 211 determines whether the flow information included in the data extracted from the payload is present in the monitor table 220. When the flow information is present in the monitor table 220, the table management unit 211 deletes the flow information extracted from the payload, the flow ID associated with the flow information, the sequence number, the registration time, and the number of failures from the monitor table 220. Thus, it is possible to suppress an increase in the amount of data in the monitor table 220.

When the flow ID is received from the monitor timer 210, the table management unit 211 deletes the flow information associated with the flow ID, the sequence number, the registration time, and the number of failures from the individual table in the monitor table 220. Thus, it is possible to suppress the increase in the amount of the data in the monitor table 220. The table management unit 211 monitors whether an available capacity of the storage unit 22 is less than a predetermined value. The predetermined value is, for example, 20% of the capacity of the storage unit 22. When the available capacity of the storage unit 22 is less than the predetermined value, the table management unit 211 deletes predetermined flow information from the monitor table 220 among the flow information registered in the monitor table 220. The predetermined flow information is, for example, the flow information of which the associated registration time is the oldest or the flow information of which the associated number of failures is the largest.

When the flow information is registered in the monitor table 220, the monitor timer 210 starts measuring a monitor period in regard to the flow corresponding to the registered flow information. When the monitor period has passed, the monitor timer 210 transmits the flow ID of the flow of which the monitor period has passed to the table management unit 211. The monitor period is a period in which it is determined whether the flow is an elephant flow. In the embodiment, the monitor period is, for example, 1 second.

When the flow ID, the flow information, the sequence number, the registration time, and the number of failures are registered in the individual table of the monitor table 220, the snoop timer 212 starts measuring a snoop period in regard to the flow corresponding to the registered flow information. When the snoop period has passed, the snoop timer 212 transmits the flow ID of the flow of which the snoop period has passed to the snoop instruction unit 213. The snoop timer 212 starts measuring the snoop period again. The snoop timer 212 repeatedly measures the snoop period during registration of the flow ID or the like of each flow in the individual table of the monitor table 220 and transmits the flow ID to the snoop instruction unit 213 when the snoop period has passed. The snoop period is a period in which it is periodically determined whether the amount of data transmitted by the flow reaches a predetermined value. In the embodiment, the snoop period is, for example, 100 milliseconds.

When the flow ID is received from the snoop timer 212, the snoop instruction unit 213 extracts the flow information associated with the received flow ID from the individual table of the monitor table 220 for each switch apparatus 30. Then, the snoop instruction unit 213 transmits the extracted flow information along with the flag indicating a snoop instruction to the PDU generation unit 215.

When the payload of the PDU is received from the PDU transmission and reception unit 216, the determination unit 214 extracts the flag and the data from the payload. When the flag extracted from the payload indicates snoop success, the sequence number is extracted from the data extracted from the payload. The determination unit 214 specifies the individual table corresponding to the switch apparatus 30 of the transmission source of the PDU with reference to the monitor table 220. The determination unit 214 extracts the flow ID and the sequence number associated with the flow information included in the data extracted from the payload from the specified individual table.

The determination unit 214 calculates an increase amount ΔS of the sequence number by subtracting the sequence number extracted from the monitor table 220 from the sequence number extracted from the payload of the PDU. The determination unit 214 determines whether the calculated increase amount ΔS is equal to or greater than a predetermined threshold value. In the embodiment, the threshold value is, for example, 1048576 which is a value corresponding to 1 MByte.

When the increase amount ΔS is equal to or greater than the predetermined threshold value, the determination unit 214 determines that the flow specified with the flow information extracted from the payload of the PDU is the elephant flow. Thus, after the flow starts, whether the flow is the elephant flow is determined based on the increase amount of the sequence number acquired from the packets snooped at predetermined intervals. Therefore, the determination unit 214 can determine the elephant flow with high precision. The determination unit 214 transmits the flow ID and the flow information regarding the flow determined to be the elephant flow along with a flag indicating the registration instruction to the PDU generation unit 215. The determination unit 214 deletes the flow ID and the flow information regarding the flow determined to be the elephant flow along with the sequence number, the registration time, and the number of failures associated with the flow ID from the monitor table 220.

When the flow information is received along with the flag indicating the snoop instruction from the snoop instruction unit 213, the PDU generation unit 215 generates a payload including the flag indicating the snoop instruction and the flow information. When the flow ID and the flow information are received along with the flag indicating the registration instruction from the determination unit 214, the PDU generation unit 215 generates a payload including a flag indicating the registration instruction, the flow ID, and the flow information. The PDU generation unit 215 generates a PDU which includes the generated payload and in which the MAC address of the switch apparatus 30 is set as a destination MAC address. The PDU generation unit 215 transmits the generated PDU to the PDU transmission and reception unit 216.

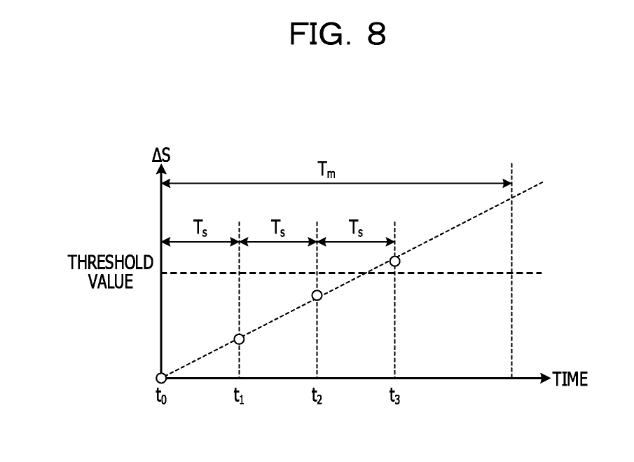

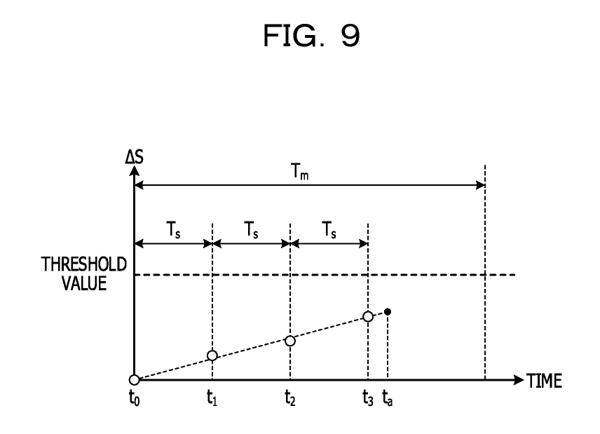

FIGS. 8 and 9 are diagrams for describing an example of a method of determining the elephant flow according to the first embodiment. FIG. 8 illustrates an example when the flow is determined to be the elephant flow. FIG. 9 illustrates an example when the flow is not determined to be the elephant flow. In the example illustrated in FIG. 8, the snoop unit 332 of the switch apparatus 30 first snoops the start packet to detect start of the flow. The PDU transmission and reception unit 310 transmits the PDU including the flag indicating reception of the start packet and the like to the identification apparatus 20. The table management unit 211 of the identification apparatus 20 registers the flow information regarding the flow including the start packet and the sequence number included in the header of the start packet in the flow table 320 at time t₀. Thus, the flow of which the flow information is registered in the flow table 320 is set as a monitoring target for which whether the flow is the elephant flow is monitored. The monitor timer 210 starts measuring a monitor period Tₘ of the flow registered in the flow table 320 from time t₀. The table management unit 211 starts measuring a snoop period T_{S} of the flow registered in the flow table 320 from time t₀.

At time t₁ at which the snoop period T_{S} has passed, the snoop instruction unit 213 transmits the flag indicating the snoop instruction or the like to the switch apparatus 30. The snoop unit 332 of the switch apparatus 30 snoops the packets included in the flow corresponding to the flow information received along with the flag indicating the snoop instruction for a predetermined time. When the packets are snooped within the predetermined time, the PDU transmission and reception unit 310 of the switch apparatus 30 transmits the PDU including the flag indicating the snoop success and the sequence number included in the headers of the snooped packets to the identification apparatus 20. The determination unit 214 of the identification apparatus 20 calculates the increase amount ΔS of the sequence number based on the sequence number included in the header of the start packet and the sequence number received along with the flag indicating the snoop success and the like from the flow table 320.

In the example illustrated in FIG. 8, at the time point of time t₁, the increase amount ΔS of the sequence number calculated from the packet snooped in response to the snoop instruction is less than a threshold value. Therefore, the information regarding the flow is not deleted from the flow table 320 and the flow is continuously set as the monitoring target. On the other hand, when the amount of data transmitted by the flow increases, the increase amount ΔS of the sequence number calculated from the packet snooped in response to the snoop instruction is equal to or greater than the threshold value, for example, at the time point of time t₃ before the monitoring period Tₘ has passed. When the increase amount ΔS is equal to or greater than the threshold value, the determination unit 214 of the identification apparatus 20 determines that the flow including the snooped packet is the elephant flow. The determination unit 214 transmits the flow information regarding the elephant flow or the like to the identification apparatus 20. The determination unit 214 deletes the flow information regarding the elephant flow or the like from the flow table 320. Thus, the flow for which the increase amount ΔS of the sequence number is determined to be equal to or greater than the threshold value is excluded from the monitoring target.

The registration unit 313 of the switch apparatus 30 registers the flow information regarding the elephant flow or the like received from the identification apparatus 20 in the flow table 320. When the packet in which the flow information registered in the flow table 320 is included in the header is received, the marking unit 336 writes the identification information indicating the packet included in the elephant flow on the header of the packet.

On the other hand, in the example illustrated in FIG. 9, the increase amount ΔS of the sequence number calculated from the packet snooped in response to the snoop instruction is less than the threshold value even at the time point of time t₃. Therefore, the flow information regarding the flow is not deleted from the flow table 320 and the flow is continuously set as the monitoring target. In the example illustrated in FIG. 9, at the time point of time tₐ, the snoop unit 332 of the switch apparatus 30 snoops the interrupt packet or the end packet to detect the end of the flow. The PDU transmission and reception unit 310 transmits the PDU including the flag indicating the end of the flow and the like to the identification apparatus 20. The table management unit 211 of the identification apparatus 20 deletes the flow information regarding the flow including the interrupt packet or the end packet from the flow table 320. Thus, the flow for which the interrupt packet or the end packet is transmitted before the flow is determined to be the elephant flow is excluded from the monitoring target.

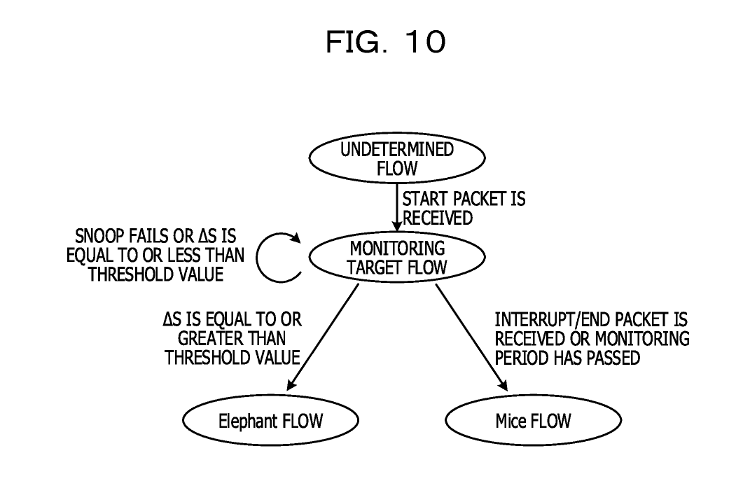

FIG. 10 is a diagram for describing an example of state transition in the determination of the elephant flow. An undetermined flow becomes a monitoring target flow when a start packet is received by the packet reception unit 330. For the monitoring target flow, a packet included in the flow is snooped for each snoop period. While the snoop fails or the increase amount ΔS of the sequence number calculated from the snooped packet is less than the threshold value, the monitoring target flow is continuously in a monitoring target state.

When the increase amount ΔS of the sequence number calculated from the snooped packet is equal to or greater than the threshold value, the monitoring target flow is determined to be the elephant flow and is excluded from the monitoring target. On the other hand, when the interrupt packet or the end packet is received or when the monitoring period has passed, the monitoring target flow is excluded from the monitoring target. The flow excluded from the monitoring target without determining that the flow is the elephant flow is determined to be, for example, a mice flow.

Operation of Switch Apparatus 30

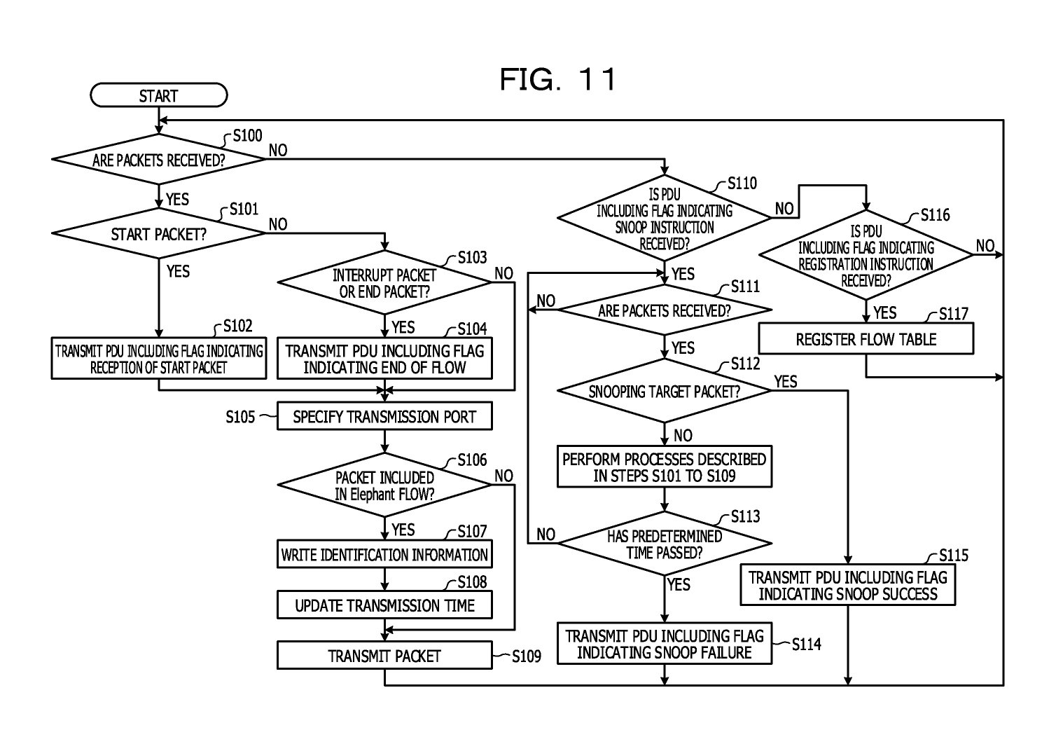

FIG. 11 is a flowchart illustrating an example of an operation of the switch apparatus 30 according to the first embodiment. First, the packet reception unit 330 determines whether to receive the packets via the reception port 34 (S100). When the packet reception unit 330 receives the packets (Yes in S100), the packet reception unit 330 transmits the received packets to the snoop unit 332 and the port specifying unit 333. The snoop unit 332 determines whether to snoop the start packet among the packets received by the packet reception unit 330 (S101). When the start packet is snooped (Yes in S101), the snoop unit 332 transmits the header of the snooped packet to the snoop control unit 312.

The snoop control unit 312 extracts the flow information regarding the flow included in the start packet and the sequence number from the header received from the snoop unit 332 and transmits the flow information and the sequence number along with the flag indicating the reception of the start packet to the PDU generation unit 311. The PDU generation unit 311 generates a payload including the flag indicating the reception of the start packet, the flow information, and the sequence number received from the snoop control unit 312. The PDU generation unit 311 generates the PDU which includes the generated payload and in which the MAC address of the identification apparatus 20 is set as the destination MAC address. The PDU transmission and reception unit 310 transmits the PDU generated by the PDU generation unit 311 to the identification apparatus 20 via the management port 37 (S102). The port specifying unit 333 performs a process described in step S105.

When the start packet is not snooped (No in S101), the snoop unit 332 determines whether the interrupt packet or the end packet is snooped among the packets received by the packet reception unit 330 (S103). When none of the interrupt packet and the end packet is snooped (No in S103), the port specifying unit 333 performs a process described in step S105.

When the interrupt packet or the end packet is snooped (Yes in S103), the snoop unit 332 transmits the header of the snooped packet to the snoop control unit 312. The snoop control unit 312 extracts the flow information regarding the flow including the interrupt packet or the end packet from the header received from the snoop unit 332 and transmits the flow information along with the flag indicating the end of the flow to the PDU generation unit 311. The PDU generation unit 311 generates a payload including the flag indicating the end of the flow and the flow information received from the snoop control unit 312. The PDU generation unit 311 generates the PDU which includes the generated payload and in which the MAC address of the identification apparatus 20 is set as the destination MAC address. The PDU transmission and reception unit 310 transmits the PDU generated by the PDU generation unit 311 to the identification apparatus 20 via the management port 37 (S104).

Next, the port specifying unit 333 specifies the port number of the transmission port 36 associated with the destination MAC address in the header of the packet received from the packet reception unit 330 with reference to the FDB 334 (S105). The port specifying unit 333 transmits the specified port number along with the packet received from the packet reception unit 330 to the determination unit 335.

The determination unit 335 determines whether the flow information in the header of the packet received from the port specifying unit 333 is registered as the flow information regarding the elephant flow in the flow table 320 with reference to the flow table 320 (S106). When the flow information in the header of the packet received from the port specifying unit 333 is not registered in the flow table 320 (No in S106), the determination unit 335 specifies the transmission queue 35 coupled to the transmission port 36 corresponding to the port number received from the port specifying unit 333. The determination unit 335 stores the packet received from the port specifying unit 333 in the specified transmission queue 35. Then, the transmission queue 35 transmits the stored packet from the transmission port 36 (S109). The packet reception unit 330 performs the process described in step S100 again.

Conversely, when the flow information in the header of the packet received from the port specifying unit 333 is registered in the flow table 320 (Yes in S106), the determination unit 335 transmits the packet received from the port specifying unit 333 along with the port number to the marking unit 336. The marking unit 336 writes the identification information indicating the packet included in the elephant flow on, for example, the DSCP field in the header of the packet received from the determination unit 335 (S107). The marking unit 336 stores the packet in which the identification information is written in the header in the transmission queue 35 coupled to the transmission port 36 corresponding to the port number received from the determination unit 335. Then, the marking unit 336 updates the transmission time stored in the flow table 320 in association with the flow information in the header of the packet received from the determination unit 335 to a current time (S108). The transmission queue 35 performs a process described in step S109.

When the packets are not received (No in S100), the snoop control unit 312 determines whether the PDU including the flag indicating the snoop instruction is received from the identification apparatus 20 via the PDU transmission and reception unit 310 (S110). When the PDU including the flag indicating the snoop instruction is received (Yes in S110), the snoop control unit 312 transmits the flow information extracted from the payload of the PDU to the snoop unit 332.

Next, the packet reception unit 330 determines whether the packets are received via the reception port 34 (S111). When the packets are received (Yes in S111), the packet reception unit 330 transmits the received packets to the snoop unit 332 and the port specifying unit 333. The snoop unit 332 determines whether the packet received by the packet reception unit 330 is a snooping target packet in which the flow information received from the snoop control unit 312 is included in the header (S112).

When the packet is not the snooping target packet (No in S112), the switch apparatus 30 performs the processes described in steps S101 to S109. The snoop unit 332 determines whether the flow information is received from the snoop control unit 312 and a predetermined time such as 50 milliseconds has passed (S113). When the predetermined time has not passed (No in S113), the packet reception unit 330 performs the process described in step S111 again.

Conversely, when the predetermined time has passed (Yes in S113), the snoop unit 332 transmits information indicating snoop failure to the snoop control unit 312. The snoop control unit 312 transmits the flow information included in the snoop instruction along with the flag indicating the snoop failure to the PDU generation unit 311. The PDU generation unit 311 generates a payload including the flag indicating the snoop failure and the flow information received from the snoop control unit 312. The PDU transmission and reception unit 310 transmits the PDU generated by the PDU generation unit 311 to the identification apparatus 20 via the management port 37 (S114). The packet reception unit 330 performs the process described in step S100 again.

When the packet received by the packet reception unit 330 is the snooping target packet (Yes in S112), the snoop unit 332 transmits the header of the snooped packet to the snoop control unit 312. The snoop control unit 312 extracts the sequence number from the header received from the snoop unit 332. The snoop control unit 312 transmits the extracted sequence number to the PDU generation unit 311 along with the flow information extracted from the payload of the PDU including the flag indicating the snoop instruction and the flag indicating the snoop success. The PDU generation unit 311 generates a payload including the flag indicating the snoop success, the flow information, and the sequence number received from the snoop control unit 312. The PDU transmission and reception unit 310 transmits the PDU generated by the PDU generation unit 311 to the identification apparatus 20 via the management port 37 (S115). The packet reception unit 330 performs the process described in step S100 again.

When the PDU including the flag indicating the snoop instruction is not received (No in S110), the registration unit 313 determines whether the PDU including the flag indicating the registration instruction is received (S116). When the PDU including the flag indicating the registration instruction is not received (No in S116), the packet reception unit 330 performs the process described in step S100 again.

Conversely, when the PDU including the flag indicating the registration instruction is received (Yes in S116), the registration unit 313 extracts the flow ID and the flow information from the payload of the PDU. The registration unit 313 registers the extracted flow information in the flow table 320 in association with the extracted flow ID. Then, the registration unit 313 registers the current time in a field of the update time in the flow table 320 in association with the flow ID extracted from the payload of the PDU (S117). The packet reception unit 330 performs the process described in step S100 again.

Operation of Identification Apparatus 20

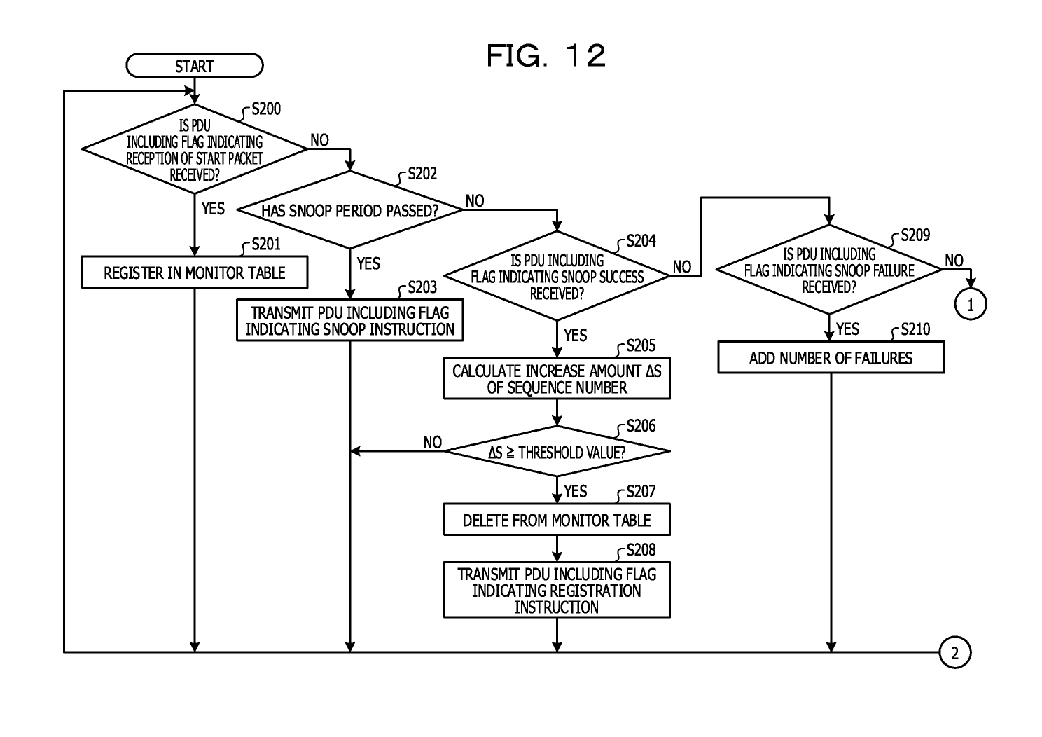

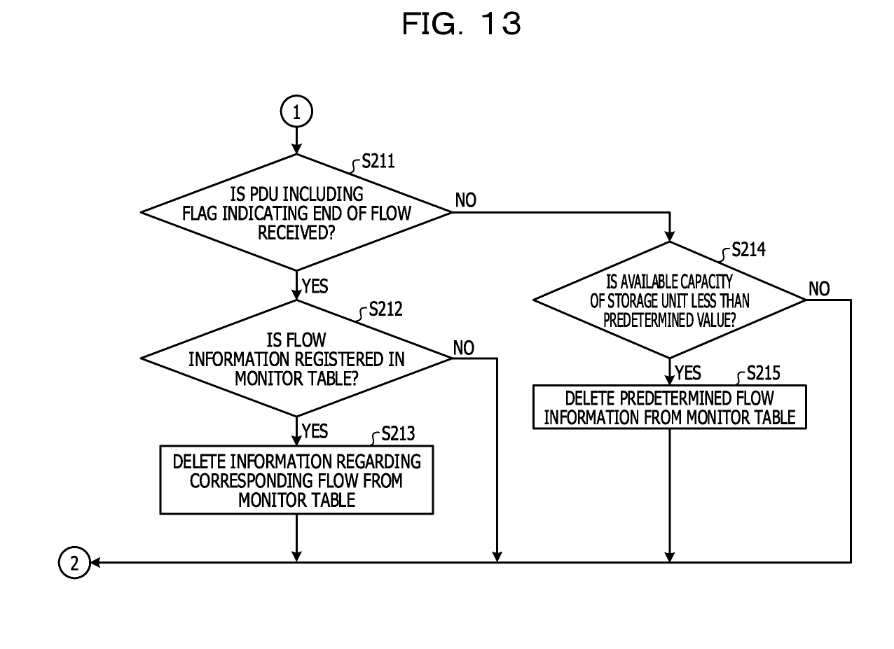

FIGS. 12 and 13 are flowcharts illustrating an example of an operation of the identification apparatus 20 according to the first embodiment. First, the table management unit 211 determines whether the PDU including the flag indicating the reception of the start packet is received from the switch apparatus 30 (S200). When the PDU including the flag indicating the reception of the start packet is received (Yes in S200), the table management unit 211 allocates the flow ID to the flow specified with the flow information extracted from the payload of the PDU. The table management unit 211 specifies the individual table corresponding to the switch apparatus 30 of the transmission source of the PDU with reference to the monitor table 220.

The table management unit 211 registers the flow information and the sequence number included in the data extracted from the payload in the specified individual table in association with the flow ID. The table management unit 211 registers the current time as a registration time in the specified individual table in association with the flow ID and registers “0” as the number of failures (S201). The monitor timer 210 starts measuring the monitor period of the flow corresponding to the flow ID registered in the monitor table 220. The snoop timer 212 starts measuring the snoop period of the flow corresponding to the flow ID registered in the monitor table 220. The table management unit 211 performs the process described in step S200 again.

When the PDU including the flag indicating the reception of the start packet is not received (No in S200), the snoop timer 212 determines whether the snoop period has passed (S202). When the snoop period has passed (Yes in S202), the snoop timer 212 transmits the flow ID of the flow of which the snoop period has passed to the snoop instruction unit 213. The snoop instruction unit 213 extracts the flow information associated with the flow ID received from the snoop timer 212 from the individual table of the monitor table 220. The snoop instruction unit 213 transmits the extracted flow information along with the flag indicating the snoop instruction to the PDU generation unit 215. The PDU generation unit 215 generates a payload including the flag indicating the snoop instruction received from the snoop instruction unit 213 and the flow information. The PDU generation unit 215 generates a PDU which includes the generated payload and in which the MAC address of the switch apparatus 30 is set as the destination MAC address. The PDU transmission and reception unit 216 transmits the PDU generated by the PDU generation unit 215 to the switch apparatus 30 via the management port 23 (S203). The table management unit 211 performs the process described in step S200 again.

When the snoop period has not passed (No in S202), the determination unit 214 determines whether the PDU including the flag indicating the snoop success is received from the switch apparatus 30 (S204). When the PDU including the flag indicating the snoop success is received (Yes in S204), the determination unit 214 specifies the individual table corresponding to the switch apparatus 30 of the transmission source of the PDU with reference to the monitor table 220. The determination unit 214 extracts the flow ID and the sequence number associated with the flow information extracted from the payload of the PDU in the specified individual table.

Next, the determination unit 214 calculates the increase amount ΔS of the sequence number by subtracting the sequence number extracted from the monitor table 220 from the sequence number extracted from the payload of the PDU (S205). The determination unit 214 determines whether the calculated increase amount ΔS is equal to or greater than a predetermined threshold value (S206). When the increase amount ΔS is less than the predetermined threshold value (No in S206), the table management unit 211 performs the process described in step S200 again.

Conversely, when the increase amount ΔS is equal to or greater than the predetermined threshold value (Yes in S206), the determination unit 214 determines that the flow specified with the flow information extracted from the payload of the PDU is the elephant flow. The determination unit 214 transmits the flow ID and the flow information regarding the flow determined to be the elephant flow along with the flag indicating the registration instruction to the PDU generation unit 215. The determination unit 214 deletes the flow ID and the flow information regarding the flow determined to be the elephant flow along with the sequence number, the registration time, and the number of failures associated with the flow ID from the monitor table 220 (S207).

Next, the PDU generation unit 215 generates the payload including the flag indicating the registration instruction, the flow ID, and the flow information received from the determination unit 214. The PDU generation unit 215 generates the PDU which includes the generated payload and in which the MAC address of the switch apparatus 30 is set as a destination MAC address. The PDU transmission and reception unit 216 transmits the PDU generated by the PDU generation unit 215 to the switch apparatus 30 via the management port 23 (S208). The table management unit 211 performs the process described in step S200 again.

When the PDU including the flag indicating the snoop success is not received (No in S204), the table management unit 211 determines whether the PDU including the flag indicating the snoop failure is received (S209). When the PDU including the flag indicating the snoop failure is received (Yes in S209), the table management unit 211 specifies the individual table corresponding to the switch apparatus 30 of the transmission source of the PDU with reference to the monitor table 220. The table management unit 211 specifies the flow information included in the data extracted from the payload in the specified individual table. The table management unit 211 adds 1 to the number of failures associated with the specified flow information (S210). The table management unit 211 performs the process described in step S200 again.

When the PDU including the flag indicating the snoop failure is not received (No in S209), the table management unit 211 determines whether the PDU including the flag indicating the end of the flow is received (S211 in FIG. 13). When the PDU including the flag indicating the end of the flow is received (Yes in S211), the table management unit 211 determines whether the flow information extracted from the payload of the PDU is registered in the monitor table 220 (S212). When the flow information extracted from the payload of the PDU is not registered in the monitor table 220 (No in S212), the table management unit 211 performs the process described in step S200 again.

Conversely, when the flow information extracted from the payload of the PDU is registered in the monitor table 220 (Yes in S212), the table management unit 211 deletes the same flow information as the flow information extracted from the payload of the PDU, the flow ID associated with the flow information, the sequence number, the registration time, and the number of failures from the monitor table 220 (S213). The table management unit 211 performs the process described in step S200 again.

When the PDU including the flag indicating the end of the flow is not received (No in S211), the table management unit 211 determines whether the available capacity of the storage unit 22 is less than the predetermined value (S214). When the available capacity of the storage unit 22 is equal to or greater than the predetermined value (No in S214), the table management unit 211 performs the process described in step S200 again. Conversely, when the available capacity of the storage unit 22 is less than the predetermined value (Yes in S214), the table management unit 211 deletes predetermined flow information among the flow information registered in the monitor table 220 from the monitor table 220 (S215). The table management unit 211 performs the process described in step S200 again.

Advantages

As described above, the information processing system 10 according to the embodiment efficiently detects a predetermined flow such as an elephant flow. The information processing system 10 according to the embodiment snoops the start packet transmitted at the time of start of the flow and specifies the monitoring target flow. Thus, detection omission of the flow is suppressed. The information processing system 10 according to the embodiment calculates the amount of data of the flow transmitted after the transmission of the start packet by using an increase amount of the sequence number of the periodically snooped packets. Thus, the amount of data of the flow is measured efficiently more than when all of the packets are captured and the amount of data of the flow is measured.

### Second Embodiment

In the information processing system 10 according to the first embodiment, the identification apparatus 20 and the switch apparatus 30 are provided as separate apparatuses. However, the present embodiment is different from the first embodiment in that the function of the identification apparatus 20 is provided in each switch apparatus 30.

Switch Apparatus 30

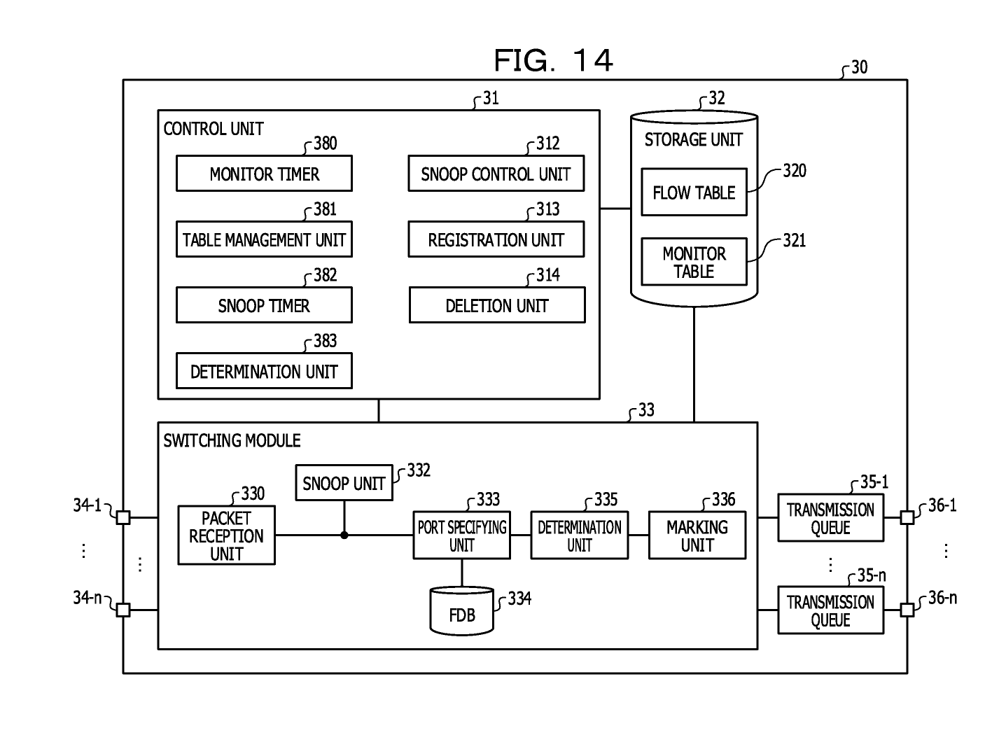

FIG. 14 is a diagram illustrating an example of a switch apparatus 30 according to a second embodiment. The switch apparatus 30 includes a control unit 31, a storage unit 32, a switching module 33, a plurality of reception ports 34-1 to 34-n, a plurality of transmission queues 35-1 to 35-n, and a plurality of transmission ports 36-1 to 36-n. The control unit 31 according to the embodiment includes a snoop control unit 312, a registration unit 313, a deletion unit 314, a monitor timer 380, a table management unit 381, a snoop timer 382, and a determination unit 383. The storage unit 32 according to the embodiment stores a flow table 320 and a monitor table 321. Since the blocks in FIG. 14 denoted by the same reference numerals as those in FIG. 2 are the same as the blocks in FIG. 2 except for the following description, the description thereof will be omitted.

In the monitor table 321, information regarding the same content as the individual table 2201 corresponding to the switch apparatus 30 provided with the monitor table 321 in the monitor table 220 described in FIG. 7 is stored.

When the header of a start packet is received from the snoop unit 332, the snoop control unit 312 extracts the flow information and the sequence number of the flow including the start packet from the received header. Then, the snoop control unit 312 transmits the extracted flow information and sequence number to the table management unit 381 along with a flag indicating reception of the start packet.

When the header of an interrupt packet or the end packet is received from the snoop unit 332, the snoop control unit 312 extracts flow information regarding the flow including an interrupt packet or an end packet from the received header. Then, the snoop control unit 312 transmits the extracted flow information to the table management unit 381 and the deletion unit 314 along with a flag indicating end of the flow.

When a flow ID is received from the snoop timer 382, the snoop control unit 312 extracts the flow information associated with the received flow ID from the monitor table 321. The snoop control unit 312 transmits the extracted flow information to the snoop unit 332. When the packet in which the flow information transmitted to the snoop unit 332 is included in the header is snooped by the snoop unit 332, the snoop control unit 312 receives the header of the snooped packet from the snoop unit 332. The snoop control unit 312 extracts the sequence number from the received header. The snoop control unit 312 transmits the extracted sequence number to the determination unit 383 along with the flow information transmitted to the snoop unit 332 and a flag indicating snoop success.

Conversely, when the packet in which the flow information transmitted to the snoop unit 332 is included in the header is not snooped by the snoop unit 332, the snoop control unit 312 receives information indicating snoop failure from the snoop unit 332. The snoop control unit 312 transmits the flow information transmitted to the snoop unit 332 to the table management unit 381 along with the flag indicating the snoop failure.

When the flow information and the sequence number are received along with the flag indicating reception of the start packet from the snoop control unit 312, the table management unit 381 allocates the flow ID to the flow specified with the received flow information. The table management unit 381 registers the flow information and the sequence number received from the snoop control unit 312 in the monitor table 321 in association with the flow ID. The table management unit 381 registers a current time as a registration time in the monitor table 321 in association with the flow ID and registers “0” as the number of failures. When the flow information is received along with the flag indicating the snoop failure from the snoop control unit 312, the table management unit 381 adds 1 to the number of failures associated with the flow information received from the snoop control unit 312.

When the flow information is received along with the flag indicating the end of the flow from the snoop control unit 312, the table management unit 381 determines whether the flow information received from the snoop control unit 312 is present in the monitor table 321. When the flow information received from the snoop control unit 312 is present in the monitor table 321, the table management unit 381 deletes the same flow information as the flow information received from the snoop control unit 312, the flow ID associated with the flow information, the sequence number, the registration time, and the number of failures from the monitor table 321. When the flow ID is received from the monitor timer 380, the table management unit 381 deletes the flow information associated with the flow ID, the sequence number, the registration time, and the number of failures from the monitor table 321.

When the flow information is registered in the monitor table 321, the monitor timer 380 starts measuring a monitor period of the flow corresponding to the registered flow information. When the monitor period has passed, the monitor timer 380 transmits the flow ID of the flow of which the monitor period has passed to table management unit 381.

When the flow information is registered in the monitor table 321, the snoop timer 382 starts measuring a snoop period of the flow corresponding to the registered flow information. When the snoop period has passed, the snoop timer 382 transmits the flow ID of the flow of which the snoop period has passed to the snoop control unit 312. The snoop timer 382 starts measuring the snoop period again.

When the flow information and the sequence number are received along with the flag indicating the snoop success from the snoop control unit 312, the determination unit 383 extracts the sequence number and the flow ID associated with the received flow information from the monitor table 321. The determination unit 383 calculates an increase amount ΔS of the sequence number by subtracting the sequence number extracted from the monitor table 321 from the sequence number received from the snoop control unit 312. The determination unit 383 determines whether the calculated increase amount ΔS is equal to or greater than a predetermined threshold value.

When the increase amount ΔS is equal to or greater than the predetermined threshold value, the determination unit 383 determines that the flow specified with the flow information received from the snoop control unit 312 is an elephant flow. The determination unit 383 transmits the flow ID of the flow determined to be the elephant flow in the registration unit 313.

The registration unit 313 extracts the flow information corresponding to the flow ID received from the determination unit 383 from the monitor table 321 and registers the extracted flow information in the flow table 320 in association with the flow ID received from the determination unit 383. The registration unit 313 deletes the flow ID received from the determination unit 383 and the flow information, the sequence number, the registration time, and the number of failures associated with the flow ID from the monitor table 321.

When an available capacity of the storage unit 32 is less than a predetermined value, the deletion unit 314 deletes predetermined flow information among the flow information registered in the monitor table 321 from the monitor table 321. The predetermined flow information is, for example, the flow information of which the associated registration time is the oldest or the flow information of which the associated number of failures is the largest among the flow information registered in the monitor table 321.

Advantages

As described above, the switch apparatus 30 according to the embodiment efficiently detects the predetermined flow such as an elephant flow. In the switch apparatus 30 according to the embodiment, a PDU is not transmitted and received with the detection of the elephant flow. Therefore, an increase in communication traffics in the information processing system 10 is suppressed.

### Third Embodiment

In the first embodiment, the amount of data transmitted by the flow has been measured from the sequence number included in the header of the periodically snooped packets and the flow of which the amount of transmitted data is equal to or greater than the predetermined amount of data has been determined to be an elephant flow. However, the present embodiment is different from the first embodiment in that an identification apparatus 20 calculates a throughput of a flow and determines that a flow with a throughput equal to or greater than a predetermined value is an elephant flow.

Identification Apparatus 20

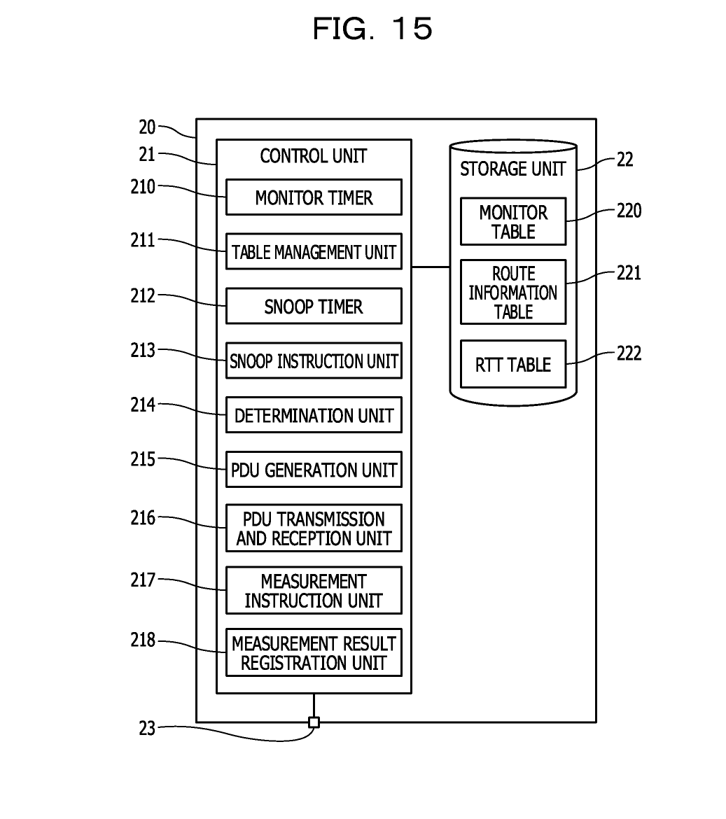

FIG. 15 is a diagram illustrating an example of the identification apparatus 20 according to a third embodiment. A control unit 21 according to the embodiment includes a monitor timer 210, a table management unit 211, a snoop timer 212, a snoop instruction unit 213, a determination unit 214, a PDU generation unit 215, a PDU transmission and reception unit 216, a measurement instruction unit 217, and a measurement result registration unit 218. A storage unit 22 according to the embodiment stores a monitor table 220, a route information table 221, and a round-trip time (RU) table 222. Since the blocks in FIG. 15 denoted by the same reference numerals as those in FIG. 6 are the same as the blocks in FIG. 6 except for the following description, the description thereof will be omitted.

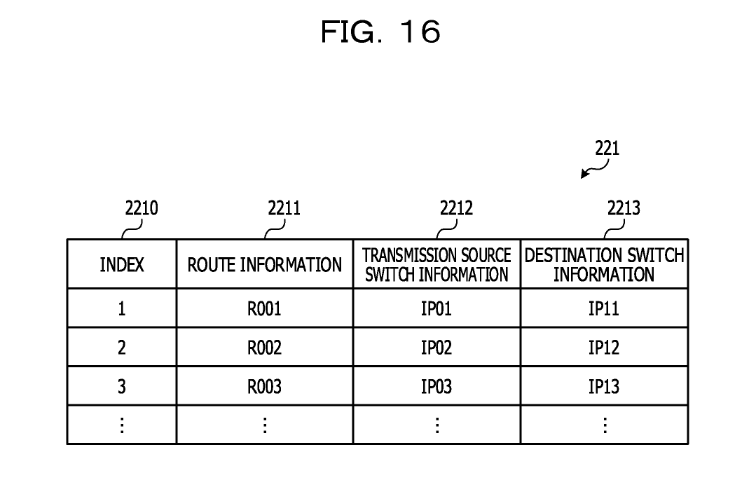

FIG. 16 is a diagram illustrating an example of the route information table 221. In the route information table 221, route information 2211, transmission source switch information 2212, and destination switch information 2213 are stored in association with an index 2210. The index 2210 is information for identifying each route in the information processing system 10 in which packets are transmitted. The route information 2211 is information regarding a route along which packets are transmitted. The transmission source switch information 2212 is an IP address of the switch apparatus 30 located at one end of a route indicated by the route information 2211. The destination switch information 2213 is an IP address of the switch apparatus 30 located at the other end of the route indicated by the route information 2211. The transmission source switch information 2212 and the destination switch information 2213 are, for example, IP addresses of the switch apparatuses 30 included in the lower switch group 12 coupled to the information processing apparatuses 14.

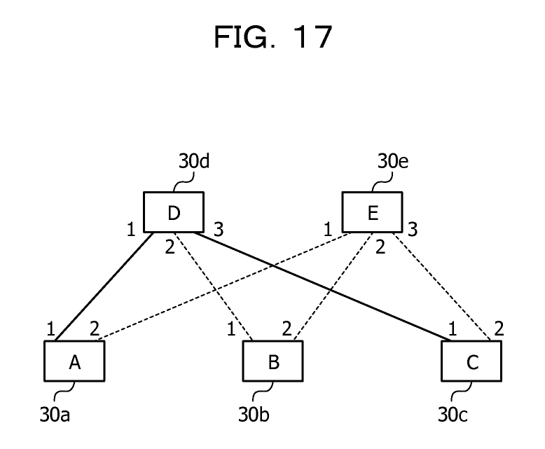

Here, for example, the route information 2211 is expressed by combinations of switch IDs of the switch apparatuses 30 included along the route and the transmission ports of the switch apparatuses 30. For example, a case in which switch apparatuses 30a, 30b, 30c, 30d, and 30e are coupled as in FIG. 17 is considered. In the example illustrated in FIG. 17, the switch ID of the switch apparatus 30a is “A”, the switch ID of the switch apparatus 30b is “B”, and the switch ID of the switch apparatus 30c is “C”. In the example illustrated in FIG. 17, the switch ID of the switch apparatus 30d is “D” and the switch ID of the switch apparatus 30e is “E”. Numerals given to the switch apparatuses 30 are transmission port numbers.

In the example illustrated in FIG. 17, route information regarding a route reaching from the switch apparatus 30a to the switch apparatus 30c along a solid-line route is denoted by, for example, “A-1-D-3-C” using the switch IDs of the switch apparatuses 30a, 30d, and 30c. Referring to the route information, it can be understood that the switch apparatus 30a with the switch ID of “A” transmits packets from the transmission port of number “1” and the switch apparatus 30d with the switch ID of “D” relays the packets. Referring to the route information, it can be understood that the switch apparatus 30d with the switch ID of “D” transmits the received packets from the transmission port of number “3” and the switch apparatus 30c with the switch ID of “C” receives the transmitted packets. Referring to the route information, it can be understood that the switch apparatus 30c with the switch ID of “C” is a termination of the route.

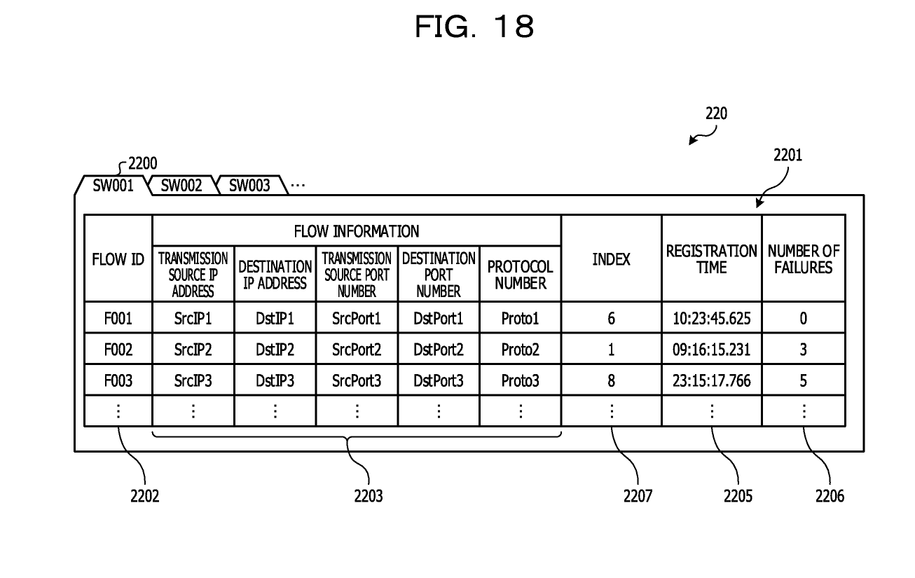

FIG. 18 is a diagram illustrating the monitor table 220 according to the third embodiment. In an individual table 2201 of the monitor table 220 according to the embodiment, a flow ID 2202, flow information 2203, an index 2207, a registration time 2205, and the number of failures 2206 are stored in association therewith. The index 2207 is information for identifying the route along which the packets are transmitted.

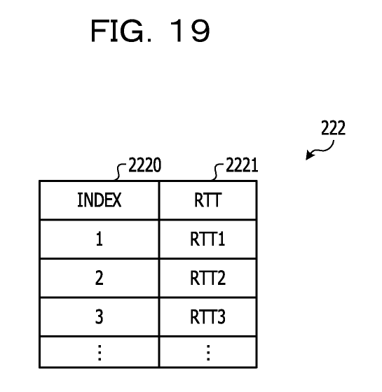

FIG. 19 is a diagram illustrating an example of the RU table 222. In the RU table 222, an RU 2221 which is a measurement value of a round-trip time measured in the route corresponding to an index 2220 is stored in association with the index 2220 for identifying each route.

Referring back to FIG. 15, the description will be continued. When a payload of a PDU is received from the PDU transmission and reception unit 216, the table management unit 211 extracts a flag and data from the payload. When the flag extracted from the payload indicates reception of a start packet, the table management unit 211 allocates to the flow ID to the flow specified with the flow information included in the data extracted from the payload. The table management unit 211 specifies the individual table corresponding to the switch apparatus 30 of the transmission source of the PDU with reference to the monitor table 220.

The table management unit 211 registers the flow information included in the data extracted from the payload and the index of the route along which the flow specified with the flow information is transmitted in the specified individual table in association with the flow ID. The table management unit 211 registers a current time as a registration time in the specified individual table in association with the flow ID and registers “0” as the number of failures.

For example, the measurement instruction unit 217 performs the following process at each predetermined timing such as 60 seconds. The measurement instruction unit 217 selects each index in the route information table 221 and extracts the route information, the transmission source switch information, and the destination switch information associated with the selected index from the route information table 221. The measurement instruction unit 217 transmits the index, the route information, the transmission source switch information, and the destination switch information along with a flag indicating a measurement instruction to the PDU generation unit 215. The PDU generation unit 215 generates a payload including the flag indicating the measurement instruction, the index, the route information, and the destination switch information received from the measurement instruction unit 217. The PDU generation unit 215 generates a PDU which includes the generated payload and in which the MAC address of the switch apparatus 30 corresponding to the transmission source switch information is set as a destination MAC address. The PDU generation unit 215 transmits the generated PDU to the PDU transmission and reception unit 216.

When the payload of the PDU is received from the PDU transmission and reception unit 216, the measurement result registration unit 218 extracts the flag and the data from the payload. When the flag extracted from the payload indicates a measurement response, the measurement result registration unit 218 registers the RU extracted from the payload in the RU table 222 in association with the index extracted from the payload.

When the payload of the PDU is received from the PDU transmission and reception unit 216, the determination unit 214 extracts the flag and the data from the payload. The data extracted from the payload includes flow information and a window size (RWIN). When the flag extracted from the payload indicates snoop success, the determination unit 214 specifies the individual table corresponding to the switch apparatus 30 of the transmission source of the PDU with reference to the monitor table 220. The determination unit 214 extracts the flow ID and the index associated with the flow information included in the data extracted from the payload from the specified individual table. The determination unit 214 extracts the RU associated with the extracted index from the RU table 222.

The determination unit 214 calculates a throughput by dividing the window size included in the data extracted from the payload by the RU extracted from the RU table 222. The determination unit 214 determines whether the calculated throughput is equal to or greater than a predetermined threshold value. In the embodiment, when a link capacity is, for example, 10 gigabits per second (Gbps), the threshold value is, for example, 1 Gbps which is 10% of 10 Gbps.

When the throughput is equal to or greater than the predetermined threshold value, the determination unit 214 determines that the flow specified with the flow information included in the data extracted from the payload is an elephant flow. Here, the window size of the information processing apparatus 14 of the reception side gradually increases from start of communication. In a flow of which the amount of transmitted data is large as in an elephant flow, a transmission time of the flow is long. Therefore, in a flow of which the amount of transmitted data is large as in an elephant flow, the window size is larger than in a flow of which the amount of transmitted data is small as in a mice flow. Therefore, the throughput obtained by dividing the window size by the RU is larger in an elephant flow than in a mice flow. Accordingly, the determination unit 214 can determine an elephant flow with high precision by measuring the throughput of the flow. The determination unit 214 transmits the flow ID and the flow information regarding the flow determined to be the elephant flow along with the flag indicating the registration instruction to the PDU generation unit 215. The determination unit 214 deletes the flow ID and the flow information regarding the flow determined to be the elephant flow along with the index, the registration time, and the number of failures associated with the flow ID from the individual table.

Switch Apparatus 30

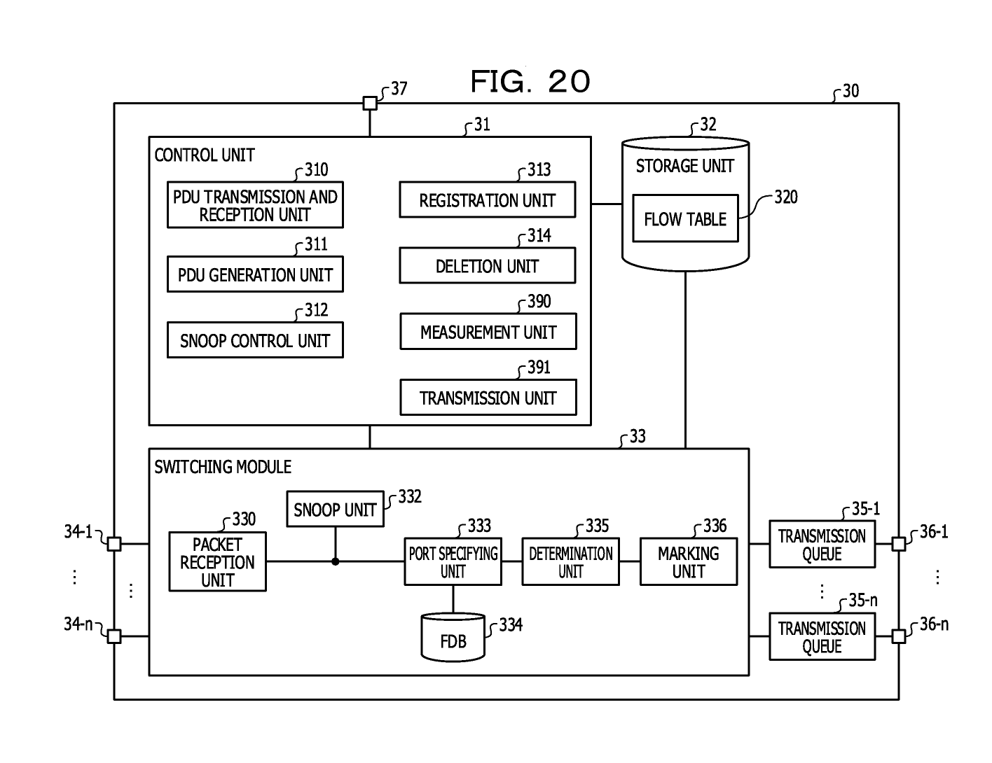

FIG. 20 is a diagram illustrating an example of the switch apparatus 30 according to the third embodiment. A control unit 31 according to the embodiment includes a PDU transmission and reception unit 310, a PDU generation unit 311, a snoop control unit 312, a registration unit 313, a deletion unit 314, a measurement unit 390, and a transmission unit 391. Since the blocks in FIG. 20 denoted by the same reference numerals as those in FIG. 2 are the same as the blocks in FIG. 2 except for the following description, the description thereof will be omitted.

When the PDU transmission and reception unit 310 receives the PDU from the identification apparatus 20 via the management port 37, the PDU transmission and reception unit 310 transmits the payload included in the received PDU to the snoop control unit 312, the registration unit 313, and the measurement unit 390.

When the payload of the PDU is received from the PDU transmission and reception unit 310, the snoop control unit 312 extracts the flag and the data from the payload. When the flag extracted from the payload is a snoop instruction, the snoop control unit 312 extracts the flow information from the data extracted from the payload. The snoop control unit 312 replaces the transmission source IP address and the destination IP address in the extracted flow information and transmits the replaced flow information to the snoop unit 332. Thus, the snoop control unit 312 causes the snoop unit 332 to snoop a response packet to the packet included in the flow specified with the flow information.

When the packet is snooped in response to the snoop instruction, the snoop control unit 312 receives the header of the snooped packet from the snoop unit 332. The snoop control unit 312 extracts the window size from the received header and transmits the extracted window size along with the flow information extracted from the payload of the PDU and the flag indicating the snoop success to the PDU generation unit 311.

When the payload of the PDU is received from the PDU transmission and reception unit 310, the measurement unit 390 extracts the flag and the data from the payload. When the flag extracted from the payload is a measurement instruction, the measurement unit 390 extracts the index, the route information, and the destination switch information from the data extracted from the payload. The measurement unit 390 generates a payload including a flag indicating a transmission instruction, the index, the route information, and the destination switch information. The measurement unit 390 generates a PDU which includes the generated payload and in which the MAC address of the switch apparatus 30 corresponding to the destination switch information is set as the destination MAC address. The measurement unit 390 stores the generated PDU in the transmission queue 35 coupled to the transmission port of the own apparatus described in the route information. The transmission queue 35 transmits the stored PDU from the transmission port 36.

When the PDU including a flag indicating a transmission response is received from the transmission unit 391, the measurement unit 390 calculates a time from transmission of the PDU including the flag indicating the transmission instruction to reception of the PDU including the flag indicating the transmission response as the RU. The measurement unit 390 extracts the index from the payload of the PDU including the flag indicating the transmission response. The measurement unit 390 transmits the calculated RU along with a flag indicating a measurement response and the index to the PDU generation unit 311. The PDU generation unit 311 generates a payload including the flag indicating the measurement response, the index, and the RU received from the measurement unit 390. The PDU transmission and reception unit 310 transmits the PDU generated by the PDU generation unit 311 to the identification apparatus 20 via the management port 37.

When the transmission unit 391 transmits the PDU including the flag indicating the transmission instruction from the packet reception unit 330, the transmission unit 391 extracts the flag and the data from the payload of the PDU. The transmission unit 391 extracts the route information from the data extracted from the payload. The transmission unit 391 determines whether the switch ID of the own apparatus is included as the switch ID of the switch apparatus 30 at a halfway point or a termination of the route in the route information with reference to the extracted route information. When the switch ID of the own apparatus is included as the switch ID of the switch apparatus 30 at the halfway point of the route in the route information, the transmission unit 391 specifies the port number associated with the switch ID of the own apparatus with reference to the route information. The transmission unit 391 stores the PDU received from the packet reception unit 330 in the transmission queue 35 coupled to the transmission port 36 corresponding to the specified port number. The transmission queue 35 transmits the stored PDU from the transmission port 36.

On the other hand, when the switch ID of the own apparatus is included as the switch ID of the switch apparatus 30 at the termination of the route in the route information, the transmission unit 391 generates the flag indicating the transmission response. The transmission unit 391 generates a payload including the index, the route information, and the destination switch information extracted from the PDU along with the flag indicating the transmission response. The transmission unit 391 generates a PDU which includes the generated payload and in which the transmission source MAC address of the PDU including the flag indicating the transmission instruction is set as the destination MAC address. The transmission unit 391 stores the generated PDU in the transmission queue 35 coupled to the transmission port 36 corresponding to the reception port 34 which receives the PDU including the flag indicating the transmission instruction. The transmission queue 35 transmits the stored PDU from the transmission port 36.

When the PDU including the flag indicating the transmission response is transmitted from the packet reception unit 330, the transmission unit 391 extracts the flag and the data from the payload of the PDU. The transmission unit 391 extracts the route information from the data extracted from the payload. The transmission unit 391 determines whether the switch ID of the own apparatus is included as the switch ID of the switch apparatus 30 of the transmission source or at a halfway point of the route in the route information with reference to the extracted route information. When the switch ID of the own apparatus is included as the switch ID of the switch apparatus 30 of the transmission source of the route in the route information, the transmission unit 391 transmits the PDU received from the packet reception unit 330 to the measurement unit 390.

On the other hand, when the switch ID of the own apparatus is included as the switch ID of the switch apparatus 30 at the halfway point of the route in the route information, the transmission unit 391 specifies the port number associated with the destination MAC address of the PDU with reference to the FBD 334. The transmission unit 391 stores the PDU received from the packet reception unit 330 in the transmission queue 35 coupled to the transmission port 36 of the specified port number. The transmission queue 35 transmits the stored PDU from the transmission port 36.

When the PDU including the flag indicating a transmission instruction or a transmission response is received from another switch apparatus 30, the packet reception unit 330 transmits the received PDU o the transmission unit 391.

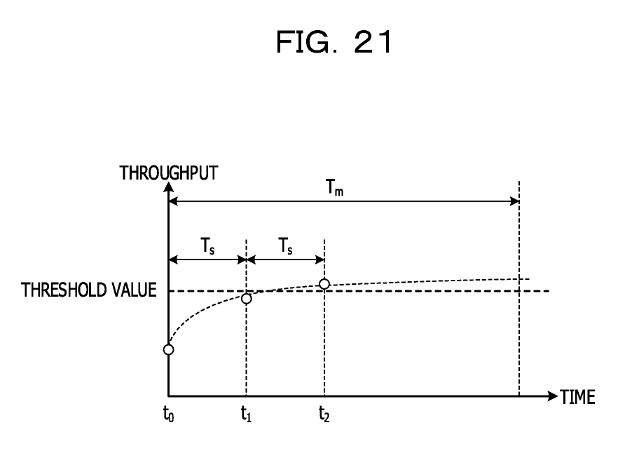

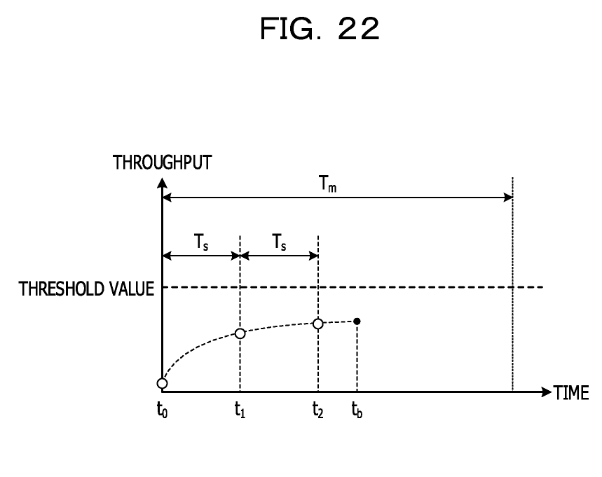

FIGS. 21 and 22 are diagrams for describing examples of a method of determining an elephant flow according to the third embodiment. FIG. 21 illustrates an example when the flow is determined to be the elephant flow. FIG. 22 illustrates an example when the flow is not determined to be the elephant flow. In the example illustrated in FIG. 21, the snoop unit 332 of the switch apparatus 30 first snoops the start packet to detect start of the flow. The PDU transmission and reception unit 310 transmits the PDU including the flag indicating reception of the start packet and the like to the identification apparatus 20. The table management unit 211 of the identification apparatus 20 registers the flow information regarding the flow including the start packet and the index identifying the route of the flow in the flow table 320 at time t₀. Thus, the flow of which the flow information is registered in the flow table 320 is set as a monitoring target for which whether the flow is the elephant flow is monitored. The monitor timer 210 starts measuring a monitor period Tₘ of the flow registered in the flow table 320 from time t₀. The table management unit 211 starts measuring a snoop period T_{S} of the flow registered in the flow table 320 from time t₀.

At time t₁ at which the snoop period T_{S} has passed, the snoop instruction unit 213 transmits the flag indicating the snoop instruction or the like to the switch apparatus 30. The snoop unit 332 of the switch apparatus 30 snoops the packets included in the flow corresponding to the flow information received along with the flag indicating the snoop instruction for a predetermined time. When the packets are snooped, the PDU transmission and reception unit 310 of the switch apparatus 30 transmits the PDU including the flag indicating the snoop success and the window size included in the headers of the snooped packets to the identification apparatus 20. The determination unit 214 of the identification apparatus 20 extracts the index associated with the flow information received along with the flag indicating the snoop success or the like from the flow table 320 and extracts the RTT associated with the extracted index from the RTT table 222. The determination unit 214 calculates the throughput of the flow by dividing the window size received along with the flag indicating the snoop success or the like by the RTT extracted from the RTT table 222.

In the example illustrated in FIG. 21, at the time point of time t₁, the throughput of the flow calculated from the packet snooped in response to the snoop instruction is less than a threshold value. Therefore, the information regarding the flow is not deleted from the flow table 320 and the flow is continuously set as the monitoring target. On the other hand, when the throughput of the flow increases, for example, the throughput of the flow calculated from the packet snooped in response to the snoop instruction is equal to or greater than the threshold value at the time point of time t₂ before the monitoring period Tₘ has passed. When the throughput of the flow is equal to or greater than the threshold value, the determination unit 214 of the identification apparatus 20 determines that the flow including the snooped packet is the elephant flow. The determination unit 214 transmits the flow information regarding the elephant flow or the like to the identification apparatus 20. The determination unit 214 deletes the flow information regarding the elephant flow or the like from the flow table 320. Thus, the flow for which the throughput is determined to be equal to or greater than the threshold value is excluded from the monitoring target.

The registration unit 313 of the switch apparatus 30 registers the flow information regarding the elephant flow or the like received from the identification apparatus 20 in the flow table 320. When the packet in which the flow information registered in the flow table 320 is included in the header is received, the marking unit 336 writes the identification information indicating the packet included in the elephant flow on the header of the packet.

On the other hand, in the example illustrated in FIG. 22, the throughput of the flow calculated from the packet snooped in response to the snoop instruction is less than the threshold value even at the time point of time t₂. Therefore, the flow information is not deleted from the flow table 320 and the flow is continuously set as the monitoring target. In the example illustrated in FIG. 22, however, the time point of time t_{b}, the snoop unit 332 of the switch apparatus 30 snoops the interrupt packet or the end packet to detect the end of the flow. The PDU transmission and reception unit 310 transmits the PDU including the flag indicating the end of the flow and the like to the identification apparatus 20. The table management unit 211 of the identification apparatus 20 deletes the flow information regarding the flow including the interrupt packet or the end packet from the flow table 320. Thus, the flow for which the interrupt packet or the end packet is transmitted before the flow is determined to be the elephant flow is excluded from the monitoring target.

Operation of Switch Apparatus 30

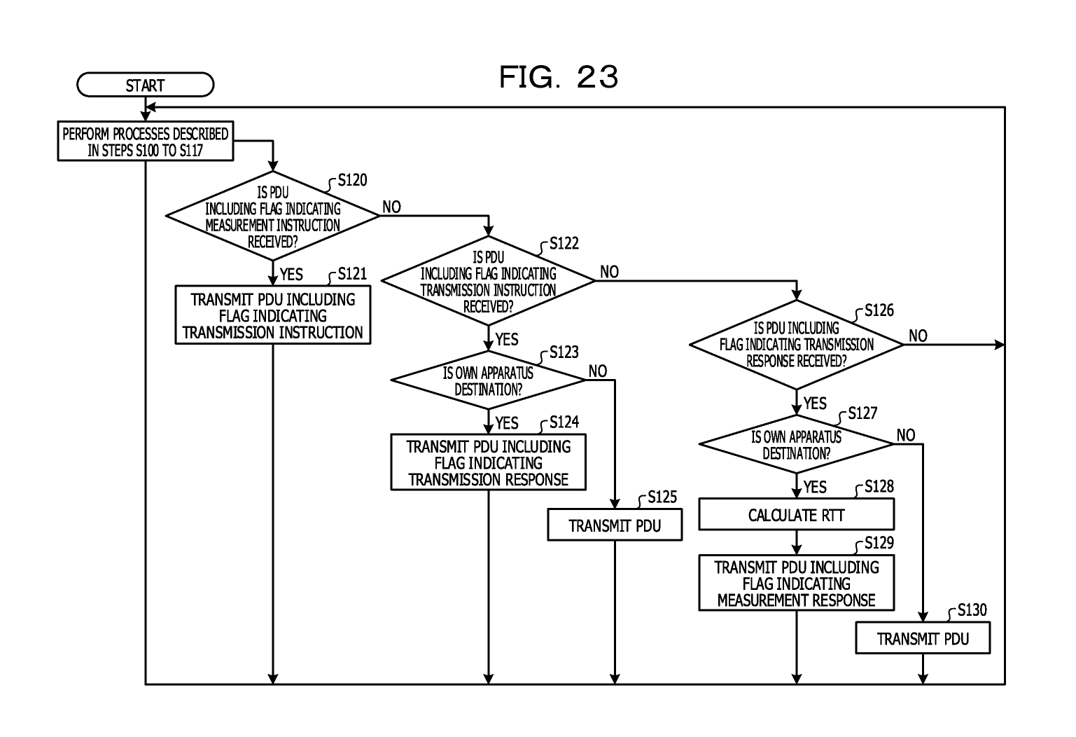

FIG. 23 is a flowchart illustrating an example of an operation of the switch apparatus 30 according to the third embodiment. Some of the processes of the operation of the switch apparatus 30 according to the embodiment are the same as the processes illustrated in FIG. 11 except for the following description. Since the processes of the switch apparatus 30 described with reference to FIG. 11 according to the first embodiment are the same as those of the embodiment, the description thereof will be omitted below.

The switch apparatus 30 performs the processes from steps S100 to S117 of FIG. 11. When the registration unit 313 determines that the PDU including the flag indicating the registration instruction is not received (No in S116 in FIG. 11), the measurement unit 390 determines whether the PDU including the flag indicating the measurement instruction is received from the identification apparatus 20 via the PDU transmission and reception unit 310 (S120). When the PDU including the flag indicating the measurement instruction is received (Yes in S120), the measurement unit 390 extracts the index, the route information, and the destination switch information from the data extracted from the payload of the PDU.

Next, the measurement unit 390 generates a payload including the flag indicating the transmission instruction, the index, the route information, and the destination switch information. The measurement unit 390 generates a PDU which includes the generated payload and in which the MAC address of the switch apparatus 30 corresponding to the destination switch information is set as the destination MAC address. The measurement unit 390 stores the generated PDU in the transmission queue 35 coupled to the transmission port of the own apparatus described in the route information. The transmission queue 35 transmits the stored PDU from the transmission port 36 (S121). The packet reception unit 330 performs the process described in step S100 again.

Conversely, when the measurement unit 390 does not receive the PDU including the flag indicating the measurement instruction (No in S120), the transmission unit 391 determines whether the PDU including the flag indicating the transmission instruction is received from the packet reception unit 330 (S122). When the PDU including the flag indicating the transmission instruction is received (Yes in S122), the transmission unit 391 extracts the route information from the payload of the PDU. The transmission unit 391 determines whether the switch ID of the own apparatus is included as the switch ID of the switch apparatus 30 of the destination in the route information with reference to the extracted route information (S123).

When the switch ID of the own apparatus is included as the switch ID of the switch apparatus 30 of the destination in the route information (Yes in S123), the transmission unit 391 generates the flag indicating the transmission response. The transmission unit 391 generates a payload including the index, the route information, and the destination switch information extracted from the PDU including the flag indicating the transmission instruction along with the flag indicating the transmission response. The transmission unit 391 generates a PDU which includes the generated payload and in which the transmission source MAC address of the PDU including the flag indicating the transmission instruction is set as the destination MAC address. The transmission unit 391 stores the generated PDU in the transmission queue 35 coupled to the transmission port 36 corresponding to the reception port 34 receiving the PDU including the flag indicating the transmission instruction. The transmission queue 35 transmits the stored PDU from the transmission port 36 (S124). The packet reception unit 330 performs the process described in step S100 again.

Conversely, when the switch ID of the own apparatus is not included as the switch ID of the switch apparatus 30 of the destination in the route information (No in S123), the transmission unit 391 specifies the port number associated with the switch ID of the own apparatus with reference to the route information. The transmission unit 391 stores the PDU received from the packet reception unit 330 in the transmission queue 35 coupled to the transmission port 36 corresponding to the specified port number. The transmission queue 35 transmits the stored PDU from the transmission port 36 (S125). The packet reception unit 330 performs the process described in step S100 again.

When the PDU including the flag indicating the transmission instruction is not received (No in S122), the transmission unit 391 determines whether the PDU including the flag indicating the transmission response is received from the packet reception unit 330 (S126). When the transmission unit 391 does not receive the PDU including the flag indicating the transmission response (No in S126), the packet reception unit 330 performs the process described in step S100 again.

Conversely, when the PDU including the flag indicating the transmission response is received (Yes in S126), the transmission unit 391 extracts the route information from the payload of the PDU. The transmission unit 391 determines whether the switch ID of the own apparatus is included as the switch ID of the switch apparatus 30 of the destination in the route information with reference to the extracted route information (S127). When the switch ID of the own apparatus is included as the switch ID of the switch apparatus 30 of the destination in the route information (Yes in S127), the transmission unit 391 transmits the PDU received from the packet reception unit 330 to the measurement unit 390.

The measurement unit 390 calculates a time from transmission of the PDU including the flag indicating the transmission instruction to reception of the PDU including the flag indicating the transmission response as the RTT (S128). The measurement unit 390 transmits the calculated RTT along with the flag indicating the measurement response and the index to the PDU generation unit 311. The PDU generation unit 311 generates a payload including the flag indicating the measurement response, the index, and the RTT received from the measurement unit 390. The PDU transmission and reception unit 310 transmits the PDU generated by the PDU generation unit 311 to the identification apparatus 20 via the management port 37 (S129). The packet reception unit 330 performs the process described in step S100 again.

Conversely, when the switch ID of the own apparatus is not included as the switch ID of the switch apparatus 30 of the destination in the route information (No in S127), the transmission unit 391 specifies the port number associated with the destination MAC address of the PDU with reference to the FBD 334. The transmission unit 391 stores the PDU received from the packet reception unit 330 in the transmission queue 35 coupled to the transmission port 36 of the specified port number. The transmission queue 35 transmits the stored PDU from the transmission port 36 (S130). The packet reception unit 330 performs the process described in step S100 again.

Operation of Identification Apparatus 20

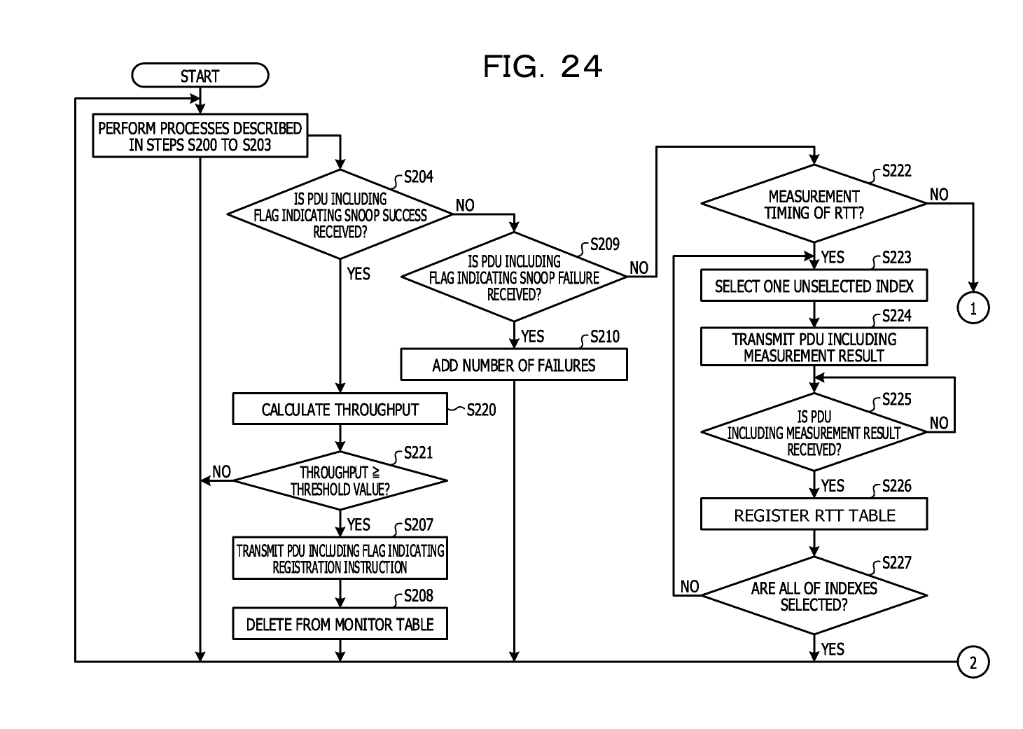

FIG. 24 is a flowchart illustrating an example of an operation of the identification apparatus 20 according to the third embodiment. Some of the processes of the operation of the identification apparatus 20 according to the embodiment are the same as the processes illustrated in FIG. 12 or 13 except for the following description. Since the processes of the identification apparatus 20 described with reference to FIG. 12 or 13 according to the first embodiment are the same as those of the embodiment, the description thereof will be omitted below.

The identification apparatus 20 performs the processes from steps S200 to S203 of FIG. 12. The determination unit 214 determines whether the PDU including the flag indicating the snoop success is received from the switch apparatus 30 (S204). When the PDU including the flag indicating the snoop success is received (Yes in S204), the determination unit 214 specifies the individual table corresponding to the switch apparatus 30 of the transmission source of the PDU with reference to the monitor table 220. The determination unit 214 extracts the flow ID and the index associated with the flow information included in the data extracted from the payload from the specified individual table. The determination unit 214 extracts the RTT associated with the extracted index from the RTT table 222.

Next, the determination unit 214 calculates the throughput by dividing the window size included in the data extracted from the payload by the RTT extracted from the RTT table 222 (S220). The determination unit 214 determines whether the calculated throughput is equal to or greater than the predetermined threshold value (S221). When the throughput is less than the predetermined threshold value (No in S221), the table management unit 211 performs the process described in step S200 again.

Conversely, when the throughput is equal to or greater than the predetermined threshold value (Yes in S221), the determination unit 214 determines that the flow specified with the flow information included in the data extracted from the payload is the elephant flow. The determination unit 214 transmits the flow ID and the flow information regarding the flow determined to be the elephant flow along with the flag indicating the registration instruction to the PDU generation unit 215. The PDU generation unit 215 generates a payload including the flag indicating the registration instruction, the flow ID, and the flow information received from the determination unit 214. The PDU generation unit 215 generates a PDU which includes the generated payload and in which the MAC address of the switch apparatus 30 set as the destination MAC address. The PDU transmission and reception unit 216 transmits the PDU generated by the PDU generation unit 215 to the switch apparatus 30 via the management port 23 (S207).

Next, the determination unit 214 deletes the flow ID and the flow information regarding the flow determined to be the elephant flow along with the index, the registration time, and the number of failures associated with the flow ID from the monitor table 220 (S208). The table management unit 211 performs the process described in step S200 again.

When the determination unit 214 does not receive the PDU including the flag indicating the snoop success (No in S204), the table management unit 211 determines whether the PDU including the flag indicating the snoop failure is received (S209). When the PDU including the flag indicating the snoop failure is received (Yes in S209), the table management unit 211 specifies the individual table corresponding to the switch apparatus 30 of the transmission source of the PDU with reference to the monitor table 220. The table management unit 211 specifies the flow information included in the data extracted from the payload in the specified individual table. The table management unit 211 adds 1 to the number of failures associated with the specified flow information (S210). The table management unit 211 performs the process described in step S200 again.

When the determination unit 214 does not receive the PDU including the flag indicating the snoop failure (No in S209), the measurement instruction unit 217 determines whether a timing is a measurement timing of the RTT (S222). When the timing is not the measurement timing of the RTT (No in S222), the identification apparatus 20 performs the processes from steps S211 to S215 illustrated in FIG. 13.

Conversely, when the timing is the measurement timing of the RTT (Yes in S222), the measurement instruction unit 217 selects one unselected index in the route information table 221 (S223). The measurement instruction unit 217 extracts the route information, the transmission source switch information, and the destination switch information associated with the selected index from the route information table 221. The measurement instruction unit 217 transmits the index, the route information, the transmission source switch information, and the destination switch information along with the flag indicating the measurement instruction to the PDU generation unit 215. The PDU generation unit 215 generates a payload including the flag indicating the measurement instruction, the index, the route information, and the destination switch information received from the measurement instruction unit 217. The PDU generation unit 215 generates a PDU which includes the generated payload and in which the MAC address of the switch apparatus 30 corresponding to the transmission source switch information is set as the destination MAC address. The PDU generation unit 215 transmits the generated PDU to the PDU transmission and reception unit 216 (S224).

Next, the measurement result registration unit 218 determines whether the PDU including the flag indicating the measurement response is received (S225). When the PDU including the flag indicating the measurement response is received (Yes in S225), the measurement result registration unit 218 extracts the index and the RU from the payload of the PDU. The measurement result registration unit 218 registers the extracted RU in the RU table 222 in association with the extracted index (S226). The measurement instruction unit 217 determines whether all of the indexes are selected in the route information table 221 (S227). When there is an unselected index (No in S227), the measurement instruction unit 217 performs the process described in step S223 again. Conversely, when the measurement instruction unit 217 selects all of the indexes (Yes in S227), the table management unit 211 performs the process described in step S200 again.

Advantages

As described above, in the information processing system 10 according to the embodiment, the predetermined flow such as an elephant flow is efficiently detected.

Hardware

The constituent elements of the units illustrated in the drawings described above may not be configured necessarily physically, as illustrated in the drawings. That is, the specific forms of distribution and integration of the units are not limited to the illustrated forms, and all or some of the specific forms can be distributed and integrated functionally or physically in any unit depending on various loads, use circumstances, or the like.

Some or all of various processing functions performed by the switch apparatus 30 may be performed on a central processing unit (CPU) (or a microcomputer such as a micro processing unit (MPU) or a micro controller unit (MCU)). Needless to say, some or all of the various processing functions may be performed on a program analyzed and executed by a CPU (or a microcomputer such as an MPU or an MCU) or hardware by wired logic.

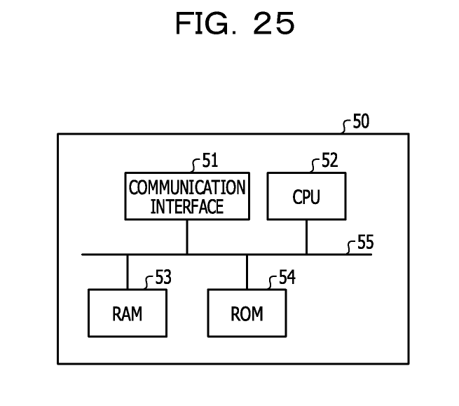

The various processes described in the foregoing embodiments can be realized by executing a program prepared in advance by the switch apparatus 30. Thus, an example of the switch apparatus 30 executing a program which has the same functions as those of the foregoing embodiments will be described below. FIG. 25 is a diagram illustrating an example of a computer 50 realizing the function of the switch apparatus 30.

As illustrated in FIG. 25, the computer 50 realizing the function of the switch apparatus 30 includes a communication interface 51, a CPU 52, a random access memory (RAM) 53, and a read-only memory (ROM) 54. The communication interface 51, the CPU 52, the RAM 53, and the ROM 54 are coupled to each other via a bus 55.

The ROM 54 stores control programs in advance. The CPU 52 reads the control programs from the ROM 54 and loads the control programs on the RAM 53. The control programs may be appropriately integrated or separated as in the constituent elements illustrated in FIG. 2, 14, or 20.

The CPU 52 reads the control programs from the ROM 54 and loads the control programs on the RAM 53. The CPU 52 realizes the same functions as those of, for example, the PDU transmission and reception unit 310, the PDU generation unit 311, the snoop control unit 312, the registration unit 313, and the deletion unit 314 by executing the control programs loaded on the RAM 53 in the foregoing first embodiment. The CPU 52 realizes the same functions as those of, for example, the packet reception unit 330, the snoop unit 332, the port specifying unit 333, the determination unit 335, and the marking unit 336 by executing the control programs loaded on the RAM 53 in the foregoing first embodiment.

The CPU 52 realizes the same functions as those of, for example, the snoop control unit 312, the registration unit 313, the deletion unit 314, the monitor timer 380, the table management unit 381, the snoop timer 382, and the determination unit 383 by executing the control programs loaded on the RAM 53 in the foregoing second embodiment. The CPU 52 realizes the same functions as those of, for example, the packet reception unit 330, the snoop unit 332, the port specifying unit 333, the determination unit 335, and the marking unit 336 by executing the control programs loaded on the RAM 53 in the foregoing second embodiment.

The CPU 52 realizes the same functions as those, for example, the PDU transmission and reception unit 310, the PDU generation unit 311, the snoop control unit 312, the registration unit 313, the deletion unit 314, the measurement unit 390, and the transmission unit 391 by executing the control programs loaded on the RAM 53 in the foregoing third embodiment. The CPU 52 realizes the same functions as those, for example, the packet reception unit 330, the snoop unit 332, the port specifying unit 333, the determination unit 335, and the marking unit 336 by executing the control programs loaded on the RAM 53 in the foregoing third embodiment.

The CPU 52 performs, for example, the processes illustrated in FIG. 11 by executing the control programs loaded on the RAM 53 in the foregoing first or second embodiment. The CPU 52 performs, for example, the processes illustrated in FIG. 23 by executing the control programs loaded on the RAM 53 in the foregoing third embodiment.

Of the processing units virtually realized by the CPU 52, all of the processing units may not be normally realized by the CPU 52 or only the processing units used for the processes may be virtually realized. All of the switch control programs may not be stored in the ROM 54 necessarily from the beginning. For example, each program may be stored in a portable recording medium such as an IC card inserted into the switch apparatus 30, and the switch apparatus 30 may acquire each program from the portable recording medium to execute the program. The switch apparatus 30 may acquire each program and cause another computer, a server apparatus, or the like storing each program to execute the program via a wireless communication line, a public line, the Internet, a LAN, a WAN, or the like.

Others

In the foregoing third embodiment, the determination unit 214 of the identification apparatus 20 has calculated the throughput based on the information regarding the window size extracted from the header of the packet included in the flow and the RU measured in the route of the flow. However, the technology of the disclosure is not limited thereto. For example, the determination unit 214 may calculate the throughput based on a snoop interval of the packets included in the flow and the sequence number extracted from the header of the snooped packet. Specifically, when ΔT is the snoop interval and ΔS is an increase amount of the sequence number from the sequence number extracted from the snooped previously packet to the sequence number extracted from the packet snooped after ΔT from the previous snoop, the determination unit 214 may calculate, for example, a value obtained by dividing ΔS by ΔT as the throughput. By using the snoop interval and the sequence number, the throughput can be measured without measuring the RTT.

In the foregoing embodiments, when the snoop period passed several times within the monitor period and whenever the snoop period passes, the identification apparatus 20 transmits the PDU including the flag indicating the snoop instruction to the switch apparatus 30. However, the technology of the disclosure is not limited thereto. For example, when the snoop period has passed, the identification apparatus 20 transmits the PDU including the flag indicating the snoop instruction to the switch apparatus 30 once. When the increase amount of the sequence number calculated from the packet snooped in response to the snoop instruction or the throughput is less than the predetermined threshold value, it may be determined that the flow is not the elephant flow without measuring the snoop period again and the flow may be excluded from the monitoring target. Thus, an increase in the communication traffic in the information processing system 10 due to the transmission of the snoop instruction is suppressed.

In the foregoing embodiments, when the snoop period has passed within the monitor period, measurement of the same monitor period starts again. However, the technology of the present disclosure is not limited thereto. The snoop timer 212 according to the first embodiment and the snoop timer 382 according to the second embodiment may change a subsequent snoop period according to a difference between the increase amount ΔS of the sequence number calculated from the packet snooped in response to the snoop instruction and a threshold value Sₜₕ of the increase amount. For example, when T_{S} is an initial value of the snoop period, the snoop timer 212 and the snoop timer 382 calculate a subsequent snoop period Tₛ′ based on the following calculation expression:

Tₛ′=Tₛ×(Sₜₕ−ΔS)/Sₜₕ

The snoop timer 212 according to the third embodiment may change a subsequent snoop period according to a difference between the throughput Th calculated from the packet snooped in response to the snoop instruction and a threshold value Thₜₕ of the throughput. For example, when Tₛ is an initial value of the snoop period, the snoop timer 212 calculates a subsequent snoop period Tₛ′ based on the following calculation expression:

Tₛ′=Tₛ×(Thₜₕ−Th)/Thₜₕ

In the foregoing embodiments, the identification apparatus 20 transmits the flow information regarding the flow determined to be an elephant flow to each switch apparatus 30, and each switch apparatus 30 records, as a transmission time, a time at which the identification information is written on the header of the packet included in the elephant flow. When the available capacity of the storage unit 32 is less than a predetermined value, each switch apparatus 30 deletes the flow information regarding the elephant flow with the longest elapsed time from a time at which the identification information is written from the flow table 320. However, the technology of the disclosure is not limited thereto.

For example, the identification apparatus 20 manages the available capacity of the storage unit 32 of each switch apparatus 30 and causes the switch apparatus 30 for which the available capacity of the storage unit 32 is less than a predetermined value to snoop the packet included in the elephant flow for a predetermined period. When the packet included in the elephant flow is not snooped within the predetermined period, the identification apparatus 20 may instruct the switch apparatus 30 for which the available capacity of the storage unit 32 is less than the predetermined value to delete the flow information regarding the elephant flow of which the packet is not snooped within the predetermined period from the flow table 320.

The information processing system 10 according to the foregoing embodiments can be applied even to an overlay network in which a plurality of logic networks are constructed through tunneling on a physical network. When the information processing system 10 according to the foregoing embodiments is applied to the overlay network, the function of the switch apparatus 30 is provided to, for example, a termination apparatus such as a VXLAN Tunnel End Point (VTEP) terminating the logic network. When the packets received from the information processing apparatus 14 are encapsulated and are packets included in the elephant flow, the termination apparatus having the function of the switch apparatus 30 writes identification information indicating the packets included in the elephant flow on a DSCP field or the like of an external header.

In the foregoing first and third embodiments, the snoop control unit 312 of each switch apparatus 30 extracts the flow information, the sequence number, or the like from the header of a predetermined packet such as the start packet snooped by the snoop unit 332. Then, the PDU transmission and reception unit 310 generates a PDU including the information extracted by the snoop control unit 312 in the payload and transmits the PDU to the identification apparatus 20. However, the technology of the disclosure is not limited thereto. For example, each switch apparatus 30 may transmit the predetermined packet or the header of the predetermined packet snooped by the snoop unit 332 to the identification apparatus 20 without processing the PDU.

In the foregoing first embodiment, the table management unit 211 of the identification apparatus 20 registers the sequence number included in the payload of the PDU in the monitor table 220 when the PDU including information regarding the start packet is received from the switch apparatus 30. The determination unit 214 calculates the increase amount ΔS of the sequence number for each snoop period by subtracting the sequence number registered in the monitor table 220 from the sequence number included in the header of the packet snooped by the switch apparatus 30. When the calculated increase amount ΔS is equal to or greater than a predetermined threshold value, the determination unit 214 determines that the corresponding flow is the elephant flow. However, the technology of the disclosure is not limited thereto.

For example, when the PDU including the information regarding the start packet is received from the switch apparatus 30, the table management unit 211 adds an increase value of the sequence number corresponding to the predetermined threshold value to the sequence number included in the payload of the PDU. The table management unit 211 registers the addition result as a threshold value of the sequence number in the monitor table 220. For each snoop period, the determination unit 214 determines whether the sequence number included in the header of the packet snooped by the switch apparatus 30 is equal to or greater than the threshold value of the sequence number registered in the monitor table 220. When the sequence number included in the header of the snooped packet is equal to or greater than the threshold value of the sequence number registered in the monitor table 220, the determination unit 214 may determine that the corresponding flow is the elephant flow. Thus, when the determination unit 214 determines whether the flow is the elephant flow for each snoop period, the determination unit 214 may perform a process of comparing the sequence number included in the header of the snooped packet to the sequence number registered in the monitor table 220. Thus, the process is simplified.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing system comprising:
a switch apparatus configured to transmit a flow received from a first information processing apparatus to a second information processing apparatus; and
an identification apparatus configured to identify a packet included in the flow received by the switch apparatus,
wherein the switch apparatus is configured to:
snoop a start packet indicating start of coupling,
snoop a packet included in a flow related to flow information for identifying the flow when a snoop instruction including the flow information is received from the identification apparatus, and
transmit the snooped packet to the identification apparatus, and
wherein the identification apparatus is configured to:
store correspondence information storing flow information regarding each flow in regard to the flow,
register flow information regarding a flow including the start packet in the correspondence information when the snooped start packet is received,
transmit the snoop instruction including the flow information regarding the flow to the switch apparatus when a first time passes in regard to each flow of which the flow information is registered in the correspondence information, and
determine whether the flow identified with the flow information included in the snoop instruction is a predetermined flow based on a value calculated from information owned by the snooped packet when the snooped packet is received from the switch apparatus in response to the snoop instruction.

2. The information processing system according to claim 1, wherein
the switch apparatus is configured to further snoop an interrupt packet indicating interrupt of the coupling and an end packet indicating end of the coupling, and
the identification apparatus is configured to:
delete the flow information regarding the flow including the interrupt packet from the correspondence information when the snooped interrupt packet is received, and
delete the flow information regarding the flow including the end packet from the correspondence information when the snooped end packet is received.

3. The information processing system according to claim 1, wherein the identification apparatus is configured to delete, from the correspondence information, flow information for which an elapsed time after registration in the correspondence information exceeds a second time longer than the first time among the flow information registered in the correspondence information.

4. The information processing system according to claim 1, wherein
the packet snooped by the switch apparatus includes a sequence number, and
the identification apparatus is configured to:
register the sequence number included in the start packet in the correspondence information in association with the flow information regarding the flow including the start packet when the start packet snooped by the switch apparatus is received, and
determine that the flow identified with the flow information included in the snoop instruction is the predetermined flow when a difference between the sequence number included in the packet snooped by the switch apparatus in response to the snoop instruction and the sequence number registered in the correspondence information in association with the flow information included in the snoop instruction is equal to or greater than a threshold value.

5. The information processing system according to claim 1, wherein
the switch apparatus is configured to:
measure a round-trip time in a route identified by route information for identifying a route along which the packet is transmitted when a measurement instruction including the route information is received from the identification apparatus,
transmit information indicating the measured round-trip time to the identification apparatus,
snoop a response packet to the packet included in the flow identified with the flow information included in the snoop instruction when the snoop instruction is received from the identification apparatus, and
transmit the snooped response packet to the identification apparatus,
the identification apparatus is configured to transmit the measurement instruction including the route information to the switch apparatus for each route information,
the correspondence information includes the route information indicating a route along which the packet included in the flow is transmitted for each flow, and
the identification apparatus is configured to:
calculate a throughput of the flow corresponding to the flow information included in the snoop instruction based on a window size included in the response packet snooped by the switch apparatus in response to the snoop instruction and the round-trip time measured in the route along which the packet included in the flow corresponding to the flow information included in the snoop instruction is transmitted, and
determine that the flow identified with the flow information included in the snoop instruction is the predetermined flow when the calculated throughput is equal to or greater than a threshold value.

6. The information processing system according to claim 5, wherein
the identification apparatus is configured to transmit a writing instruction including the flow information regarding the flow determined to be the predetermined flow to the switch apparatus, and
the switch apparatus is configured to write information indicating that the packet is included in the predetermined flow in a header of the received packet when the packet included in the flow corresponding to the flow information included in the writing instruction received from the identification apparatus is received.

7. A method of controlling an information processing system including a switch apparatus configured to transmit a flow received from a first information processing apparatus to a second information processing apparatus and an identification apparatus configured to identify a packet included in the flow received by the switch apparatus, the method comprising:
snooping, by the switch apparatus, a start packet indicating start of coupling;
snooping, by the switch apparatus, a packet included in a flow related to flow information for identifying the flow when a snoop instruction including the flow information is received from the identification apparatus;
transmitting, by the switch apparatus, the snooped packet to the identification apparatus;
storing, by the identification apparatus, correspondence information storing flow information regarding each flow in regard to the flow;
registering, by the identification apparatus, flow information regarding a flow including the start packet in the correspondence information when the snooped start packet is received;
transmitting, by the identification apparatus, the snoop instruction including the flow information regarding the flow to the switch apparatus when a first time passes in regard to each flow of which the flow information is registered in the correspondence information; and
determining, by the identification apparatus, whether the flow identified with the flow information included in the snoop instruction is a predetermined flow based on a value calculated from information owned by the snooped packet when the snooped packet is received from the switch apparatus in response to the snoop instruction.

8. The method according to claim 7, wherein
the switch apparatus is configured to further snoop an interrupt packet indicating interrupt of the coupling and an end packet indicating end of the coupling, and
the method further comprising:
deleting, by the identification apparatus, the flow information regarding the flow including the interrupt packet from the correspondence information when the snooped interrupt packet is received; and
deleting, by the identification apparatus, the flow information regarding the flow including the end packet from the correspondence information when the snooped end packet is received.

9. The method according to claim 7, further comprising:
deleting, by the identification apparatus, from the correspondence information, flow information for which an elapsed time after registration in the correspondence information exceeds a second time longer than the first time among the flow information registered in the correspondence information.

10. The method according to claim 7, wherein
the packet snooped by the switch apparatus includes a sequence number, and
the method further comprising:
registering, by the identification apparatus, the sequence number included in the start packet in the correspondence information in association with the flow information regarding the flow including the start packet when the start packet snooped by the switch apparatus is received; and
determining, by the identification apparatus, that the flow identified with the flow information included in the snoop instruction is the predetermined flow when a difference between the sequence number included in the packet snooped by the switch apparatus in response to the snoop instruction and the sequence number registered in the correspondence information in association with the flow information included in the snoop instruction is equal to or greater than a threshold value.

11. The method according to claim 7, wherein the correspondence information includes route information indicating a route along which the packet included in the flow is transmitted for each flow, and
the method further comprising:
measuring, by the switch apparatus, a round-trip time in a route identified by route information for identifying a route along which the packet is transmitted when a measurement instruction including the route information is received from the identification apparatus;
transmitting, by the switch apparatus, information indicating the measured round-trip time to the identification apparatus;
snooping, by the switch apparatus, a response packet to the packet included in the flow identified with the flow information included in the snoop instruction when the snoop instruction is received from the identification apparatus;
transmitting, by the switch apparatus, the snooped response packet to the identification apparatus;
transmitting, by the identification apparatus, the measurement instruction including the route information to the switch apparatus for each route information;
calculating, by the identification apparatus, a throughput of the flow corresponding to the flow information included in the snoop instruction based on a window size included in the response packet snooped by the switch apparatus in response to the snoop instruction and the round-trip time measured in the route along which the packet included in the flow corresponding to the flow information included in the snoop instruction is transmitted; and
determining, by the identification apparatus, that the flow identified with the flow information included in the snoop instruction is the predetermined flow when the calculated throughput is equal to or greater than a threshold value.

12. The method according to claim 11, further comprising:
transmitting, by the identification apparatus, a writing instruction including the flow information regarding the flow determined to be the predetermined flow to the switch apparatus; and
writing, by the switch apparatus, information indicating that the packet is included in the predetermined flow in a header of the received packet when the packet included in the flow corresponding to the flow information included in the writing instruction received from the identification apparatus is received.

13. An apparatus configured to identify a packet included in a flow received by a switch apparatus, the switch apparatus being configured to transmit the flow received from a first information processing apparatus to a second information processing apparatus, the apparatus comprising:
a storage unit configured to store correspondence information storing flow information regarding each flow in regard to the flow; and
a controller coupled to the storage unit and configured to:
when a snooped start packet which the switch apparatus snooped a start packet indicating start of coupling is received, register flow information regarding a flow including the start packet in the correspondence information,
transmit a snoop instruction including the flow information regarding the flow to the switch apparatus when a first time passes in regard to each flow of which the flow information is registered in the correspondence information, the switch apparatus snooping a packet included in the flow related to the flow information in the snoop instruction and transmitting the snooped packet to the apparatus, and
determine whether the flow identified with the flow information included in the snoop instruction is a predetermined flow based on a value calculated from information owned by the snooped packet when the snooped packet is received from the switch apparatus in response to the snoop instruction.

14. The apparatus according to claim 13, wherein the controller is configured to:
delete flow information regarding a flow including a interrupt packet indicating interrupt of the coupling from the correspondence information when a snooped interrupt packet which the switch apparatus snooped the interrupt packet is received from the switch apparatus, and
delete flow information regarding a flow including an end packet indicating end of the coupling from the correspondence information when the snooped end packet which the switch apparatus snooped the end packet is received from the switch apparatus.

15. The apparatus according to claim 13, wherein the controller is configured to:
delete, from the correspondence information, flow information for which an elapsed time after registration in the correspondence information exceeds a second time longer than the first time among the flow information registered in the correspondence information.

16. The apparatus according to claim 13, wherein
the packet snooped by the switch apparatus includes a sequence number, and
the controller is configured to:
register the sequence number included in the start packet in the correspondence information in association with the flow information regarding the flow including the start packet when the start packet snooped by the switch apparatus is received, and
determine that the flow identified with the flow information included in the snoop instruction is the predetermined flow when a difference between the sequence number included in the packet snooped by the switch apparatus in response to the snoop instruction and the sequence number registered in the correspondence information in association with the flow information included in the snoop instruction is equal to or greater than a threshold value.

17. The apparatus according to claim 13, wherein
the correspondence information includes route information indicating a route along which the packet included in the flow is transmitted for each flow, and
the controller is configured to:
transmit a snoop instruction including flow information to the switch apparatus, the snoop instruction instructing the switch apparatus to snoop a response packet to the packet included in the flow identified with the flow information,
transmit a measurement instruction including route information for identifying a route along which the packet is transmitted to the switch apparatus for each route information, the switch apparatus measuring a round-trip time in the route identified by the route information in response to receiving of the measurement instruction and transmitting the round-trip time to the apparatus,
calculate a throughput of the flow corresponding to the flow information included in the snoop instruction based on a window size included in the response packet and the round-trip time from the switch apparatus,
determine that the flow identified with the flow information included in the snoop instruction is the predetermined flow when the calculated throughput is equal to or greater than a threshold value.

18. The apparatus according to claim 17, wherein
the controller is configured to transmit a writing instruction including the flow information regarding the flow determined to be the predetermined flow to the switch apparatus, and
the switch apparatus is configured to write information indicating that the packet is included in the predetermined flow in a header of the received packet when the packet included in the flow corresponding to the flow information included in the writing instruction received from the apparatus is received.
